(19) United States
(12) Patent Application Publication
(10) Pub. No.: US 2018/0089815 A1
(43) Pub. Date: Mar. 29, 2018

(54) Functionality Analysis Method and Apparatus for Given 3D Models

(71) Applicant: Shenzhen University, Shenzhen City (CN)

(72) Inventors: Ruizhen HU, Shenzhen City (CN); Hui HUANG, Shenzhen City (CN); Hao ZHANG, Shenzhen City (CN)

(21) Appl. No.: 15/604,690

(22) Filed: May 25, 2017

(30) Foreign Application Priority Data
Sep. 27, 2016 (CN) 201610855491.7

(51) Int. Cl. G06T 7/00; G06T 7/32; G06T 17/05

(52) U.S. Cl. CPC G06T 7/001; G06T 17/05; G06T 7/32

(57) ABSTRACT

The present invention provides a functionality analysis method and apparatus of given 3D models. This functionality analysis method comprises: computing interaction context for the central object given in each scene; building the correspondence among those scenes based on the computed interaction context; extracting the functional patches on each central object in each scene based on the built correspondence, and forming a set of proto-patches which is a key component of the functionality model; computing a set of geometric features on the sampled points on each consisting functional patch for each proto-patch; learning a regression model from the geometric features on sample points to their weights for each proto-patch; computing the unary and binary features of each functional patch; and refining the feature combination weights to get the final functionality model. This invention doesn't rely on the interaction between human and the central object and can handle any static interaction between all kinds of objects; without complex operations like labeling all the dataset, users can get the corresponding results directly.

### CROSS REFERENCE TO RELATED APPLICATIONS

The present invention claims priority of CN Application No. 201610855491.7, filed on Sep. 27, 2016, and the entirety of which is incorporated by reference herein.

### FIELD OF THE INVENTION

The presented invention provides a new technique in the field of computer graphics, especially about functionality analysis method and apparatus for given 3D models.

### BACKGROUND OF THE INVENTION

Functionality is one of the key aspects that guides object designs and has always been considered as the major criteria for classifying different categories of objects. So, functionality analysis and recognition plays an important role in shape understanding. Recently in shape analysis, an increasing effort has been devoted to extracting high-level and semantic information from geometric objects and dataset, especially man-made shapes. More and more researchers are shifting their attention from geometry analysis, to structural analysis, and ultimately to functional analysis. It is a critical time to make significant advances in the last front, while all current existing works on high-level shape analysis works haven't really reached the goal for functionality analysis. Ongoing pursuits on functional shape analysis have represented functionality in different manners:

Structure-Based Analysis Method:

Shape structure is about the arrangement and relations between shape parts, e.g., symmetry, proximity, and orthogonality. In retrospect, many past works on structure-aware analysis [1] are connected to functional analysis, but typically, the connections are either insufficient or indirect for acquiring a functional understanding of shapes. For example, symmetry is relevant to functionality since symmetric parts tend to perform the same functions. However, merely detecting symmetric parts does not reveal what functionalities the parts perform. In addition, not all structural relations are functional.

Recent works along this direction generalize shape structures by learning statistics of part relations [2]or surfaces [3]via co-analyses. The first step of all these methods usually is to get a structural segmentation and representation for the given shapes and then analyze the common structural properties shared by those shapes from the same categories. However, this kind of co-analysis is constrained by the formal structural segmentation and cannot be extended to arbitrary object categories. Moreover, both the training and testing data for inferring meta representations come with semantic segmentations, which in some sense, already assume a functional understanding of the object category.

The major drawback of structure-based analysis method is that their analysis is purely based on the structural parts and the possible functional structure or labels of each category have to be known beforehand. It's hard to build the essential connection between functionality and structure.

Affordance-Based Analysis Method:

In the field of robotics, there has been intensive work on modeling interactions and affordances, with the motivation of using such a model to control a robot that interacts with an environment. Many of the methods proposed in the field are agent-based, where the functionality of an object is identified with an indirect shape analysis based on interactions of an agent ([4][5][6][7]). Given a template of the agent (e.g., a human), these methods find a correspondence between an interaction pose of the agent and a specific functionality, which is called an affordance model. With such a model, the methods can predict the interacting pose for an unknown shape and then assign a specific functionality to the shape based on the matching between the predicted pose and a functionality.

The major drawback of those affordance-based methods is that they simplify the concept of functionality and indirectly map it to the human poses. On a more conceptual level, how an object functions is not always well reflected by interactions with human poses. For example, consider a drying rack with hanging laundry; there is no human interaction involved. Even if looking only at human poses, one may have a hard time discriminating between certain objects, e.g., a hook and a vase, since a human may hold these objects with a similar pose. Last but not the least, even if an object is designed to be directly used by humans, human poses alone cannot always distinguish its functionality from others. For example, a human can carry a back-pack while sitting, standing or walking. The specific pose of the human does not allow us to infer the functionality of the backpack.

Model-Based Analysis Method:

Model-based methods derive the functionality of shapes by matching them to pre-defined models of functional requirements. The pre-defined models can be directly defined on the shape surface which is more direct and doesn't require semantic segmentation. However, in all the previous works, all those models are handcrafted. For example, a model is handcrafted for a given object category to recognize the functional requirements that objects in the category must satisfy, e.g., the containment of a liquid or stability of a chair. As a result, this kind of method require quite strong prior knowledge on the dataset which cannot be easily satisfied and it would be a big challenge for normal users.

The major drawback of these methods is that they didn't make full use of the latest technique and big dataset. It's unrealistic to manually find all the structural and geometric properties that are required for functionality analysis of any given object category.

### REFERENCE

[1]. MITRA, N., WAND, M., ZHANG, H., COHEN-OR, D., AND BOKELOH, M. 2013. Structure-aware shape processing. In Eurographics State-of-the-art Report (STAR)
[2]. FISH, N., A VERKIOU, M., VAN KAICK, O., SORKINE, HORNUNG, O, COHEN-O R, D., AND MITRA, N. J. 2014. Meta-representation of shape families. ACM Trans. on Graphics 33, 4, 34:1-11
[3]. YUMER, M. E., CHAUDHURI, S., HODGINS, J. K., AND KARA, L. B. 2015. Semantic shape editing using deformation handles. ACM Trans. on Graphics 34, 4, 86:1-12.
[4]. BAR-AVIV, E., AND RIVLIN, E. 2006. Functional 3D object classification using simulation of embodied agent. In British Machine Vision Conference, 32:1-10.
[5]. GRABNER, H., GALL, J., AND VANGOOL, L. 2011. What makes a chair a chair? In Proc. IEEE Conf. on Computer Vision & Pattern Recognition, 1529-1536.
[6]. KIM, V. G., CHAUDHURI, S., GUIBAS, L., AND FUNKHOUSER, T. 2014. Shape2Pose: Human-centric shape analysis. ACM Trans. on Graphics 33, 4, 120:1-12
[7]. LAGA, H., MORTARA, M., AND SPAGNUOLO, M. 2013. Geometry and context for semantic correspondence and functionality recognition in manmade 3D shapes. ACM Trans. on Graphics 32, 5, 150:1-16.

### [8]. SAVVA, M., CHANG, A. X., HANRAHAN, P., FISHER, M., AND NIESSNER, M.

2014. SceneGrok: Inferring action maps in 3D environments. ACM Trans. on Graphics 33, 6, 212:1-10.

[9]. STARK, L., AND BOWYER, K. 1996. Generic Object Recognition Using Form and Function. World Scientific.
[10]. HU, R., ZHU, C., VAN KAICK, O., LIU, L., SHAMIR, A., AND ZHANG, H. 2015. Interaction context (ICON): Towards a geometric functionality descriptor. ACM Trans. on Graphics 34, 4, 83:1-12.
[11]. SCHMIDT, M., VAN DEN BERG, E., FRIEDLANDER, M. P., AND MURPHY, K. 2009. Optimizing costly functions with simple constraints: A limited-memory projected quasi-Newton algorithm. In Proc. Int. Conf. AI and Stat., 456-463.

### SUMMARY OF THE INVENTION

The embodiments of the present invention provide a functionality analysis method and apparatus for given 3D models to automatically learn the common properties share by objects from the same category and build the corresponding functionality model which can be used to recognize the functionality of an individual 3D object.

In order to achieve the above object, the embodiments of the present invention provide a functionality analysis method for given 3D models, comprising:

computing interaction context for the central object given in each scene, where the interaction context is a hierarchical structure which encodes the interaction bisector surface and interaction region between the central object and any interacting object, and the central object needs to be put in a scene to compute the corresponding interaction context;

building the correspondence among those scenes based on the computed interaction context;

extracting the functional patches on each central object in each scene based on the built correspondence, and forming a set of proto-patches which is a key component of the functionality model;

sampling a set of points on each consisting functional patch for each proto-patch and computing a set of geometric features;

learning a regression model from the geometric features on sample points to their weights for each proto-patch;

computing the unary and binary features of each functional patch, where the unary features encode the geometric feature of each single functional patch while the binary feature encode the structural relation between any two functional patches; and

refining the feature combination weights to get the final functionality model, where the feature combination weights are used to combine those unary and binary features.

In one embodiment, building the correspondence among those scenes based on the computed interaction context, further comprising:

getting the correspondence between each pair of scenes based on the subtree isomorphism between the interaction contexts of those two scenes; and

building a correspondence across the whole set of scenes by selecting the optimal path from those binary correspondences between all pairs of scenes.

In one embodiment, building a correspondence across the whole set of scenes by selecting the optimal path from those binary correspondences between all pairs of scenes, further comprising:

building a graph for the given scene dataset, where each node corresponds to the central object of one scene and each edge encodes the distance between the interaction contexts of those two central objects corresponding to the two connecting nodes; and

finding the minimal spanning tree of the graph mentioned above, and then expanding the correspondence between each pair of scenes to the whole set based on the spanning tree.

In one embodiment, expanding the correspondence between each pair of scenes to the whole set based on the spanning tree, further comprising:

randomly picking one node in the scene graph as the root node, and finding the nodes that directly connect to the root to determine the initial set of correspondences; and

using Breadth-First-Search method to recursively propagate the already determined correspondence between the parent node and children nodes to the next level of children nodes.

In one embodiment, extracting the functional patches on each central object in each scene based on the built correspondence, further comprising:

getting the interacting objects that corresponding to the nodes on the first level of each interaction context in each scene; and

computing the interaction regions between those interacting objects and the central object and then getting the functional patches on each central object.

In one embodiment, the interaction region is represented by a weight assignment on all the sampled points where the weight indicates the importance of the point to the specific interaction region.

In one embodiment, each functional patch has a corresponding functional space, which is the empty space needed for the interacting object and central object to perform such interaction and bounded by the intersection bisector surface between the central object and interacting objects.

In one embodiment, each proto-patch consists of a set of corresponding functional patches and functional space and the functional space of the proto-patch is then defined as the intersection of all the corresponding functional spaces after aligned.

In one embodiment, the geometric features computed for each sample point include how linear-, planar- and spherical-shaped the neighborhood of the point is, the angle between the normal of the point and the upright direction of the shape, angles between the covariance axes and the upright vector, height feature, the relation between the point and the shape's convex hull, and ambient occlusion.

In one embodiment, computing how linear-, planar- and spherical-shaped the neighborhood of the point is, further comprising:

taking a small geodesic neighborhood of each sampled point on the given object;

computing the eigen values λ₁, λ₂, λ₃ and corresponding eigenvectors μ₁, μ₂, μ₃ of the neighborhood's covariance matrix, where λ₁≧λ₂≧λ₃≧0; and

defining the features which indicate how linear (L)-, planar (P)- and spherical (S)-shaped the neighborhood of the point is respectively as:

$$L = \frac{{λ}_{1} - {λ}_{2}}{{λ}_{1} + {λ}_{2} + {λ}_{3}} ; P = \frac{2 ( {λ}_{2} - {λ}_{3} )}{{λ}_{1} + {λ}_{2} + {λ}_{3}} ; S = \frac{3 {λ}_{3}}{{λ}_{1} + {λ}_{2} + {λ}_{3}} .$$

In one embodiment, computing the relation between the point and the shape's convex hull further comprising: connecting a line segment from the point to the center of the shape's convex hull and recording the length of this segment and the angle of the segment with the upright vector.

In one embodiment, computing the unary features of each functional patch based on the geometric features further comprising: computing the point-level geometric feature first and then building a histogram capturing the distribution of the point-level features in such patch.

In one embodiment, computing the binary features of each pair of functional patches, further comprising:

for each pair of functional patches of any central object in a scene, connecting a line segment from a sampled point on one patch to any sampled point on the other patch, and computing the length of this segment and the angle of the segment with the upright vector; and

building a histogram capturing the distribution of the segment lengths and angles computed from all the pairs of sampled points.

In one embodiment, refining the feature combination weights to get the final functionality model, further comprising:

S1: setting the initial feature combination weights as uniform weights and getting the initial functionality model;

S2: using the learned regression model to predict the functional patches on each central object and getting the initial set of functional patches;

S3: for each initial functional patch, computing the initial unary feature distance between this initial functional patch and the proto-patch of the initial functionality model, which results in a set of minimal unary feature distances;

S4: for each pair of initial functional patches, computing the initial binary feature distance between this initial functional patches and the proto-patches of the initial functionality model, which results in a set of minimal binary feature distances;

S5: combining those initial sets of minimal unary and binary feature distances using the initial set of feature combination weights to get the initial functionality score for each central object;

S6: representing the functionality score can as a function of the weights on the points sampled on the functional patches and refining the points weights and thus functional patches by optimizing the functionality score;

S7: repeating S3 to S6 to refine the functional patches till converge to get the optimal functionality scores under the initial feature combination weights;

S8: using metric learning to optimize the feature combination weights to update the initial functionality model; and

S9: repeating S2 to S8 to refine the feature combination weights till converge to get the optimal functionality model.

In order to achieve the above object, the embodiments of the present invention further provide a functionality analysis apparatus for given 3D models, which comprising:

an interaction context computation unit configured to compute interaction context for the central object given in each scene, where the interaction context is a hierarchical structure which encodes the interaction bisector surface and interaction region between the central object and any interacting object and the central object needs to be put in a scene to compute the corresponding interaction context;

a correspondence establish unit configured to build the correspondence among those scenes based on the computed interaction context;

a proto-patch extraction unit configured to extract the functional patches on each central object in each scene based on the built correspondence, and forming a set of proto-patches which is a key component of the functionality model;

a geometric feature computation unit configured to sample a set of points on each consisting functional patch for each proto-patch and compute a set of geometric features;

a regression model learning unit configured to learn a regression model from the geometric features on sample points to their weights for each proto-patch;

a patch feature computation unit configured to compute the unary and binary features of each functional patch, where the unary features encode the geometric feature of each single functional patch while the binary feature encode the structural relation between any two functional patches; and

a functionality model establish unit configured to refine the feature combination weights to get the final functionality mode, where the feature combination weights are used to combine those unary and binary features.

In one embodiment, the correspondence establish unit further comprises:

a first correspondence establish module configured to get the correspondence between each pair of scenes based on the subtree isomorphism between the interaction contexts of those two scenes;

a second correspondence establish module configured to build a correspondence across the whole set of scenes by selecting the optimal path from those binary correspondences between all pairs of scenes.

In one embodiment, the second correspondence establish module further comprises:

a graph construction module configured to build a graph for the given scene dataset, where each node corresponds to the central object of one scene and each edge encodes the distance between the interaction contexts of those two central objects corresponding to the two connecting nodes; and

a correspondence propagation module configured to find the minimal spanning tree of the graph mentioned above, and then propagate the correspondence between each pair of scenes to the whole set based on the spanning tree.

In one embodiment, the correspondence propagation module further comprises:

a children node determination module configured to randomly pick one node in the scene graph as the root node, and find the nodes that directly connect to the root to determine the initial set of correspondences; and

a correspondence propagation module configured to recursively propagate the already determined correspondence between the parent node and children nodes to the next level of children nodes using Breadth-First-Search method.

In one embodiment, the proto-patch extraction unit further comprises:

an interacting object determination module configured to get the interacting objects that corresponding to the nodes on the first level of each interaction context in each scene; and

a functional patch localization module configured to compute the interaction regions between those interacting objects and the central object and then get the functional patches on each central object.

In one embodiment, the interaction region is represented by a weight assignment on all the sampled points where the weight indicates the importance of the point to the specific interaction region.

In one embodiment, that each functional patch has a corresponding functional space, which is the empty space needed for the interacting object and central object to perform such interaction and bounded by the intersection bisector surface between the central object and interacting objects.

In one embodiment, each proto-patch consists of a set of corresponding functional patches and functional space and the functional space of the proto-patch is then defined as the intersection of all the corresponding functional spaces after aligned.

In one embodiment, the geometric features computed for each sample point include how linear-, planar- and spherical-shaped the neighborhood of the point is, the angle between the normal of the point and the upright direction of the shape, angles between the covariance axes and the upright vector, height feature, the relation between the point and the shape's convex hull, and ambient occlusion.

In one embodiment, the geometric feature computation unit further comprises:

a neighborhood determination module configured to take a small geodesic neighborhood for each sampled point;

the first computation module configured to compute the eigenvalues λ₁, λ₂, λ₃ and corresponding eigenvectors μ₁, μ₂, μ₃ of the neighborhood's covariance matrix, where λ₁≧λ₂≧λ₃≧0; and
the second computation module configured to define the features which indicate how linear (L)-, planar (P)- and spherical (S)-shaped the neighborhood of the point is respectively as:

$$L = \frac{{λ}_{1} - {λ}_{2}}{{λ}_{1} + {λ}_{2} + {λ}_{3}} ; P = \frac{2 ( {λ}_{2} - {λ}_{3} )}{{λ}_{1} + {λ}_{2} + {λ}_{3}} ; S = \frac{3 {λ}_{3}}{{λ}_{1} + {λ}_{2} + {λ}_{3}} .$$

In one embodiment, computing the relation between the point and the shape's convex hull further comprises connecting a line segment from the point to the center of the shape's convex hull and recording the length of this segment and the angle of the segment with the upright vector.

In one embodiment, the patch feature computation module is used to compute the unary features of each functional patch based on the geometric features, which means to compute the point-level geometric feature first and then build a histogram capturing the distribution of the point-level features in such patch.

In one embodiment, the patch feature computation module for binary feature further comprises:

a point-level feature computation module configured to connect a line segment from a sampled point on one patch to any sampled point on the other patch for each pair of functional patches of any central object in a scene, and compute the length of this segment and the angle of the segment with the upright vector; and

a histogram construction module configured to build a histogram capturing the distribution of the segment lengths and angles computed from all the pairs of sampled points and get the final binary feature.

In one embodiment, the functionality model establish unit further comprises:

an initial functionality model generation module configured to set the initial feature combination weights as uniform weights and get the initial functionality model;

an initial functional patch localization module which uses the learned regression model to predict the functional patches on each central object and gets the initial set of functional patches;

a unary feature computation module configured to compute the initial unary feature distance between each initial functional patch and the proto-patch of the initial functionality model, resulting in a set of minimal unary feature distances;

a binary feature computation module configured to compute the initial binary feature distance between each pair of initial functional patches and the proto-patches of the initial functionality model, which results in a set of minimal binary feature distances;

a functionality score computation module configured to combine those initial sets of minimal unary and binary feature distances using the initial set of feature combination weights to get the initial functionality score for each central object;

a functional patch optimization module configured to represent the functionality score as a function of the weights on the points sampled on the functional patches and refine points weights and thus functional patches by optimizing the functionality score;

a functionality score optimization module configured to repeat S3 to S6 to refine the functional patches till converge to get the optimal functionality scores under the initial feature combination weights;

a functionality model optimization module, which uses metric learning to optimize the feature combination weights, to update the initial functionality model; and

a functionality model finalization module configured to repeat S2 to S8 to refine the feature combination weights till converge to get the optimal functionality model.

This invention doesn't rely on the interaction between human and the central object and can handle any static interaction between all kinds of objects; without complex operations like labeling all the dataset, users can get the corresponding results directly.

### BRIEF DESCRIPTION OF THE DRAWINGS

In order to more clearly describe the technical solutions in the embodiments of the present invention or the prior art, accompanying drawings to be used in the descriptions of the embodiments or the prior art will be briefly introduced as follows. Obviously, the accompanying drawings in the following descriptions just illustrate some embodiments of the present invention, and a person skilled in the art can obtain other accompanying drawings from them without paying any creative effort.

FIG. 1 shows a flowchart of a functionality analysis method for given 3D objects in an embodiment of the present invention;

FIG. 2A-2C illustrates how the proposed functionality analysis method works in an embodiment of the present invention;

FIG. 3 illustrates the functionality model we learned for the handcart category in an embodiment of the present invention;

FIG. 4 illustrates the geometric descriptor of object-to-object interaction in an embodiment of the present invention;

FIG. 5 illustrates examples of interaction context and their subtree isomorphism in an embodiment of the present invention;

FIG. 6 illustrates the correspondence across multiple scenes in an embodiment of the present invention;

FIG. 7 illustrates one handcart in the scene and three different functional patches corresponding to different types of interactions in the scene in an embodiment of the present invention;

FIG. 8 illustrates the functional space for the interaction between human and chair;

FIG. 9 illustrates some examples of proto-patches in an embodiment of the present invention;

FIG. 10 shows a flowchart of the computation pipeline of the functionality analysis method in an embodiment of the present invention;

FIG. 11 illustrates the prediction process of the learned functionality model in an embodiment of the present invention;

FIG. 12 illustrates some prediction results in an embodiment of the present invention in an embodiment of the present invention;

FIG. 13 shows the evaluation of the learned functionality models in an embodiment of the present invention;

FIG. 14 shows the example query used for user study in an embodiment of the present invention;

FIG. 15 shows the result of the user study in an embodiment of the present invention;

FIG. 16 illustrates the embedding of the shapes in the dataset, according to the functionality distance and the similarity of light field descriptors in an embodiment of the present invention;

FIG. 17 illustrates the results of multi-function detection in an embodiment of the present invention;

FIG. 18 shows a flowchart of the developed functionality analysis apparatus in an embodiment of the present invention;

FIG. 19 shows a flowchart of the correspondence establish unit in an embodiment of the present invention;

FIG. 20 shows a flowchart of the second correspondence establish module in an embodiment of the present invention;

FIG. 21 shows a flowchart of the correspondence propagation module in an embodiment of the present invention;

FIG. 22 shows a flowchart of the proto-patch extraction unit in an embodiment of the present invention;

FIG. 23 shows a flowchart of the geometric feature computation unit in an embodiment of the present invention;

FIG. 24 shows a flowchart of the patch feature computation module in an embodiment of the present invention;

FIG. 25 shows a flowchart of the functionality model establish unit in an embodiment of the present invention;

FIG. 26 shows a flowchart of the apparatus of the present invention in an embodiment of the present invention.

### DETAILED DESCRIPTION OF THE PREFERRED EMBODIMENTS

The technical solutions in the embodiments of the present invention will be clearly and completely described as follows with reference to the accompanying drawings of the embodiments of the present invention. Obviously, those described herein are just parts of the embodiments of the present invention rather than all the embodiments. Based on the embodiments of the present invention, any other embodiment obtained by a person skilled in the art without paying any creative effort shall fall within the protection scope of the present invention.

Technical Terms Used in the Present Invention:

Interaction context: shape descriptor used to describe the interaction between the given object (central object in the scene) and the other interacting object in the scene.

Functional patch: the interaction region on the central object that plays an important role when interacting with other objects.

Proto-patch: a set of corresponding functional patches.

Unary feature: geometric features of each functional patch.

Binary feature: features that encode the relation between any pair of functional patches.

Feature combination weights: weights that indicates the importance of different features and are used to combine those feature distances into functionality score.

The main goal of this invention is to learn a functionality model for an object category by co-analyzing a set of objects from the same category such that we can predict the functionality of any given individual 3D object (the 3D model of the given object). More specifically, the input to the learning scheme is a collection of shapes belonging to the same object category, e.g., a set of handcarts, where each shape is provided within a scene context. To represent the functionalities of an object in the model, we capture a set of patch-level unary and binary functional properties. These functional properties of patches describe the interactions that can take place between a central object and other objects, where the full set of interactions characterizes the single or multiple functionalities of the central object. The model goes beyond providing a functionality-oriented descriptor for a single object; it prototypes the functionality of a category of 3D objects by co-analyzing typical interactions involving objects from the category. Furthermore, the co-analysis localizes the studied properties to the specific locations, or surface patches, that support specific functionalities, and then integrates the patch-level properties into a category functionality model. Thus, the model focuses on the how, via common interactions, and where, via patch localization, of functionality analysis. With the learned functionality models for various object categories serving as a knowledge base, we are able to form a functional understanding of an individual 3D object, without a scene context. With patch localization in the model, functionality-aware modeling, e.g., functional object enhancement and the creation of functional object hybrids, is made possible.

Based on the above analysis, the present invention provides a functionality analysis method and apparatus for given 3D models.

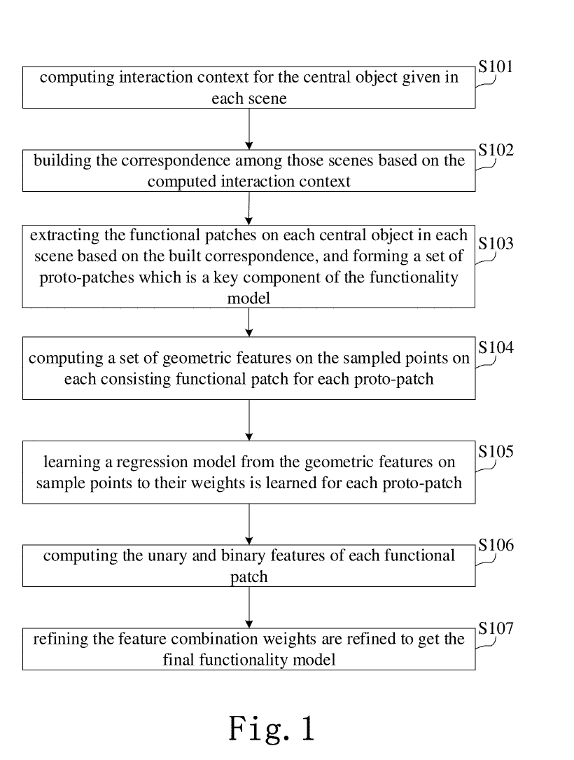

FIG. 1 shows a flowchart of a functionality analysis method for given 3D objects in an embodiment of the present invention. As shown in FIG. 1, the functionality analysis method for given 3D models comprises:

S101: computing interaction context for the central object given in each scene, where the interaction context is a hierarchical structure which encodes the interaction bisector surface and interaction region between the central object and any interacting object, and the central object needs to be put in a scene to compute the corresponding interaction context;

S102: building the correspondence among those scenes based on the computed interaction context;

S103: extracting the functional patches on each central object in each scene based on the built correspondence, and forming a set of proto-patches which is a key component of the functionality model;

S104: sampling a set of points on each consisting functional patch for each proto-patch and computing a set of geometric features;

S105: learning a regression model from the geometric features on sample points to their weights for each proto-patch;

S106: computing the unary and binary features of each functional patch, where the unary features encode the geometric feature of each single functional patch while the binary feature encode the structural relation between any two functional patches; and

S107: refining the feature combination weights to get the final functionality model, where the feature combination weights are used to combine those unary and binary features.

As can be seen from the flow of FIG. 1, the present invention firstly computes interaction context for the central object given in each scene, builds the correspondence among those scenes based on the computed interaction context, extracts the functional patches and functional patches for the given object, computes the unary and binary features of functional patches, and finally refines the feature combination weights to get the final functionality model. The present invention doesn't rely on the interaction between any agent and the central object and can handle any static interaction between all kinds of objects; without complex operations like labeling all the dataset, users can get the corresponding results directly.

With the learned functionality models for various object categories serving as a knowledge base, we are able to predict the functional patches on any new individual 3D model without a scene context and compute the corresponding functionality score.

The functionality analysis method provided in the present inversion consists of three main steps: 1) design functionality model; 2) learn functionality model; 3) use functionality model for prediction.

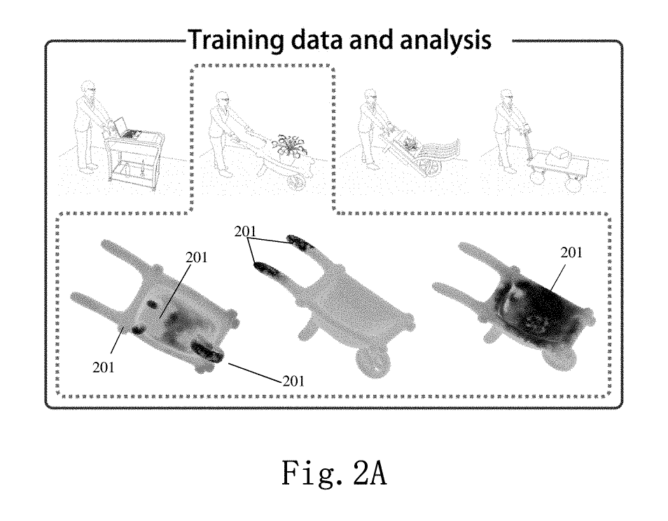

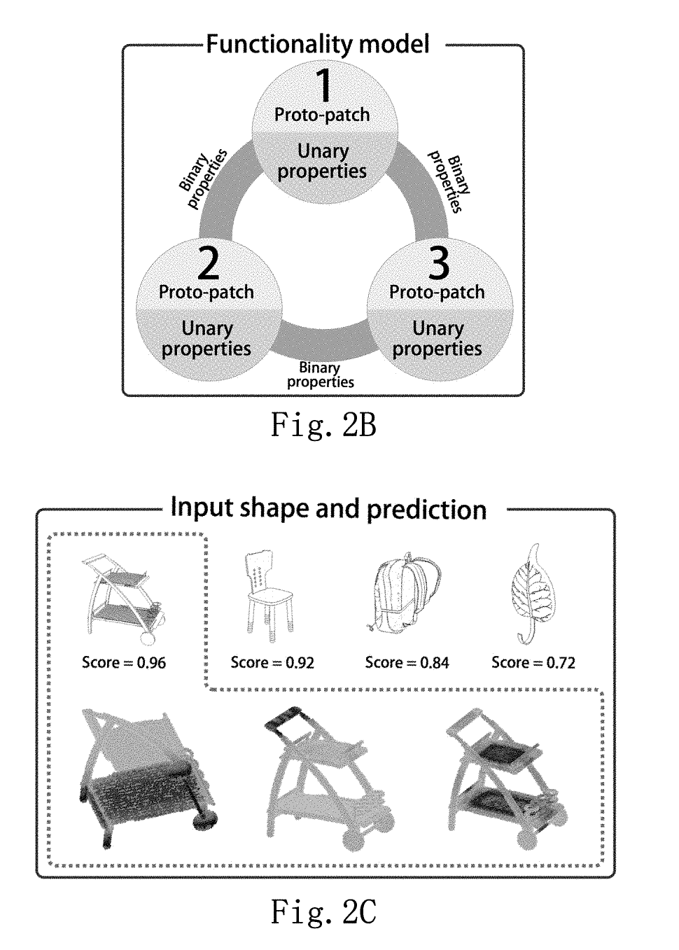

FIG. 2A-2C shown how the functionality model is designed, learned and used. FIG. 2A shows an example of the input, i.e., a set of objects of the same category, where each testing object is given in the context of a scene, which are called central objects. Here we can see 4 handcarts in the first row which are the central objects, while all other objects in each scene are called interacting object, including the ground which supports the handcart, human pushing the handcart and objects putting on the handcart. The method detects functional patches that support different types of interactions between objects and builds the correspondence across the whole set. Example patches of the second handcart are shown as a color map on the surface of the shape in the second row, indicated by 201, where values closer to black indicate that a point belongs to the patch with higher probability. FIG. 2B shows the structure of the functionality model we learnt, which describes functionality in terms of proto-patches that summarize the patches in the collection with their properties. FIG. 2C shows how the functionality model is used for functionality analysis of given new 3D models. Given an unknown 3D object in isolation, we use the model to predict how well the object supports the functionality of the category, which we call functionality score. This is done by estimating the location of functional patches on the object and computing its similarity to the proto-patches in the functionality model.

Followings are some more details of each step:

1) Design Functionality Model

To learn the functionality model, we need to determine the model structure first, i.e., what the model should consist of. Since the goal to not only recognize the functionality of given shape but also locate the functional region on the shape, we decide to build the functionality model on the surface patches. Comparing to those traditional models defined on semantic parts, surface patches are more flexible and have less requirements on the input shapes. For example, for a given mug, if we want to analyze its functionality based on the traditional part-level functionality model, we need segment the mug into the handle part and the body part first. However, the inner region of the mug body and the outer base of the mug body function in different ways, i.e., the inner region functions as a container while the outer base provides stable support for the mug. To be able to encode functionality in a geometric way so that we can use the functionality model to predict the functionality based on the shape geometry later, we need further extract a set of unary and binary features of those surface patches. FIG. 2B shows the structure of the functionality model we learned.

2) Learn Functionality Model

To be able to localize the functional patches, we put all the models that we are going to analyze the functionality into static scenes, and then extract the corresponding functional patches to form the proto-patches by co-analyzing the interactions in those scenes. Each proto-patch corresponds to one type of interaction. As shown in FIG. 2A, by putting the handcarts into those scenes indicating how they work and analyzing the interaction between the handcarts and other interacting objects in the scenes, the proposed method extract the functional patches corresponding to different types of interactions. In the second row, from left to the right we can see the interaction regions corresponding to interaction with ground, human and the objects on the handcart. After co-analyzing the interactions in all the scenes in the dataset and establishing the correspondence among those functional patches, we obtain the functionality model shown in FIG. 2B.

To learn the functionality model for some object category, the complete input consists of a collection of shapes belonging to the same object category as positive examples and another collection of shapes belonging to other categories as negative examples. Note that each shape in the positive set is provided within a scene context.

The output of the method is the functionality model of such object category which includes the regression models for initial functional patch prediction, unary and binary features of the proto-patches and their corresponding combination weights. The details of how the model is learned will be explained more in the next section since prediction is used during the learning scheme.

3) Use Functionality Model for Prediction

Given an unknown 3D object in isolation, to be able to estimate how well the object supports some specific functionality, this invention predicts the location of functional patches on the object and computes the its similarity to the proto-patches in the functionality model. More specifically, by solving an optimization problem, we find the surface patches on the given object which match best to the proto-patches encoded in the corresponding functionality model, and then we measure the similarity by comparing a set of unary and binary features over those patches to get the final functionality score. The functionality score of each shape is defined with respect to some specific functionality category, thus for the given shape, it would have different functionality scores when considering different object categories, and likewise, different shapes usually will have different scores with respect to the same object category. FIG. 1C shows the functionality scores of different shapes with respect to the functionality model of handcart. Moreover, with patch localization on the given shape during the prediction, functionality-aware modeling, e.g., functional object enhancement and the creation of functional object hybrids, is made possible.

To perform the functionality prediction using the learnt functionality model, the input is an individual 3D shape, and the output is the corresponding functionality score and functional patches on the shape.

In one embodiment, the model can be described as a collection of functional patches originating from the objects in a specific category. Each object contributes one or more patches to the model, which are clustered together as proto-patches. The model also contains unary properties of the patches, binary properties between patches, and a global set of feature weights that indicate the relevance of each property in describing the category functionality.

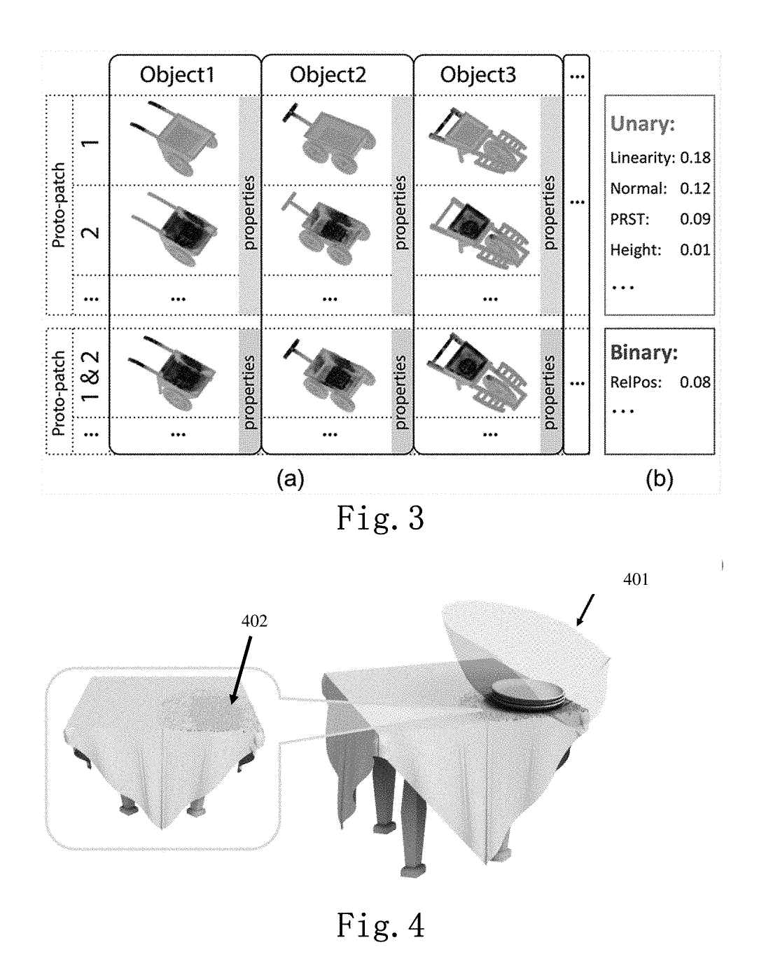

More formally, a proto-patch Pᵢ={Uᵢ, Sᵢ} represents a patch prototype that supports a specific type of interaction, and encodes it as distributions of unary properties Uᵢ of the patch, and the functional space Sᵢ surrounding the patch. The functionality model is denoted as [symbol] ={P, B, Ω}, where P={Pᵢ} is a set of proto-patches, B={B_{i,j}} are distributions of binary properties defined between pairs of proto-patches, and Ω is a set of weights indicating the relevance of unary and binary properties in describing the functionality. FIG. 3 shows one example of the functionality model, where (a) shows a collection of functional patches and their unary and binary properties, and (b) shows a set of weights defining the importance of each property for representing the functionality of the category.

We define a set of abstract unary properties [symbol] ={uₖ}, such as the normal direction of a patch, and a set of abstract binary properties [symbol] ={bₖ}, such as the relative orientation of two different patches. We learn the distribution of values for these unary and binary properties for each object in the category. For the i-th proto-patch, u_{i,k} encodes the distribution of the k-th unary property, and for each pair i, j of proto-patches, b_{i,j,k} encodes the distribution of the k-th binary property. Using these properties, the set Uᵢ={u_{i,k}} captures the geometric properties of proto-patch i in terms of the abstract properties U, and similarly the set B_{i,j}={b_{i,j,k}} captures the general arrangement of pairs of proto-patches i and j in terms of the properties in B. Since the functional space is more geometric in nature, Sᵢ is represented as a closed surface.

In one embodiment, according to S102, based on the subtree isomorphism between the interaction contexts of each pair of scenes, we get the correspondence between those two scenes; For a dataset consists of a set of different scenes, we build a correspondence across the whole set by selecting the optimal path from those binary correspondences between all pairs of scenes.

More specifically, building a correspondence across the whole set by selecting the optimal path from those binary correspondences between all pairs of scenes, further comprises: building a graph for the given scene dataset, where each node corresponds to the central object of one scene and each edge encodes the distance between the interaction contexts of those two central objects corresponding to the two connecting nodes; finding the minimal spanning tree of the graph mentioned above, and then expanding the correspondence between each pair of scenes to the whole set based on the spanning tree.

Expanding the correspondence between each pair of scenes to the whole set based on the spanning tree, further comprises: randomly picking one node in the scene graph as the root node, and finding the nodes that directly connect to the root to determine the initial set of correspondences; using Breadth-First-Search method to recursively propagate the already determined correspondence between the parent node and children nodes to the next level of children nodes.

Given a set of 3D shapes from the same object category, where each shape is provided within a scene context, the goal is to learn the corresponding functionality model by co-analyzing the interactions in those scenes.

Given a set of shapes, we initially describe each scene in the in-put with an interaction context (ICON) descriptor [10]. We briefly describe this descriptor here for completeness, and then explain how it is used in the co-analysis and model construction.

ICON encodes the pairwise interactions between the central object and the remaining objects in a scene. To compute an ICON descriptor, each shape is approximated with a set of sample points. Each interaction is described by features of an interaction bisector surface (IBS) 401 and an interaction region (IR) 402, as shown in FIG. 4. The IBS is defined as a subset of the Voronoi diagram computed between two objects and represents the spatial region between them. The IR is the region on the surface of the central object that corresponds to the interaction captured by the IBS. The features computed for the IBS and IR capture the geometric properties that describe the interaction between two objects, but in a manner that is less sensitive to the specific geometry of the objects.

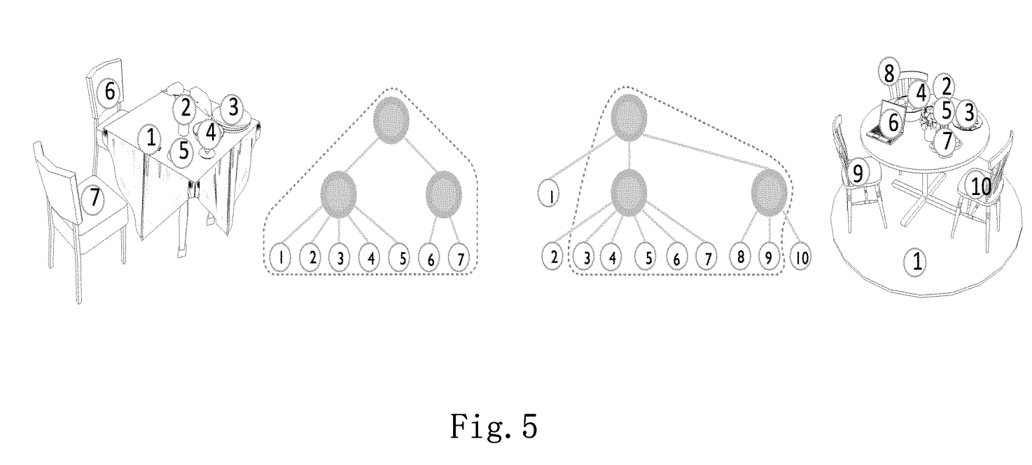

All the interactions of a central object are organized in a hierarchy of interactions, called the ICON descriptor. The leaf nodes of the hierarchy represent single interactions, while the intermediate nodes group similar types of interactions together. FIG. 5 shows two examples of the ICON descriptors for two different scenes. Different interacting objects in the scenes are indicated by different numbers and each interacting object corresponds to one leaf node in the hierarchy. Two nodes sharing the same parent nodes means the corresponding interactions with the central objects are similar. For those two tables placed in two different scenes, we can measure their functional similarity by searching the subtree isomorphism between their ICON, as shown in the middle indicated by the dashed lines. We can see they those two tables share similar functionality even though there are large variations in their geometry and structure. Each ICON descriptor may have multiple associated hierarchies. Thus, to represent the central object, we select the hierarchy that minimizes the average distance to the hierarchies of all the other central objects in the training set for the given category. The tree distance is derived from the quality of a subtree isomorphism, which is computed between two hierarchies based on the IBS and IR descriptors.

The goal of the co-analysis is to cluster together similar interactions that appear in different scenes. Given the ICONs of all the central objects in the input category, we first establish a correspondence between all the pairs of ICON hierarchies. The correspondence for a pair is derived from the same subtree isomorphism used to compute a tree distance.

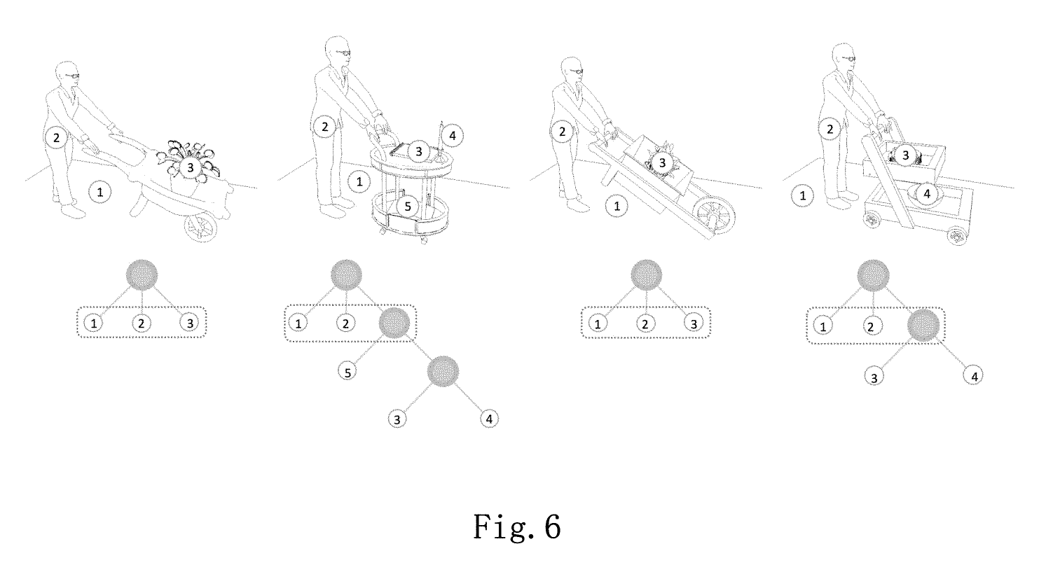

Since we aim for a coherent correspondence between all the interactions in the category, we apply an additional refinement step to ensure coherency. We construct a graph where each vertex corresponds to a central object in the set, and every two objects are connected by an edge whose weight is the distance between their ICON hierarchies. We compute a minimum spanning tree of this graph, and use it to propagate the correspondences across the set. We start with a randomly selected root vertex and establish correspondences between the root and all its children (the vertices connected to the root). Next, we recursively propagate the correspondence to the children in a breadth first manner. In each step, we reuse the correspondence already found with the tree isomorphism. This propagation ensures that cycles of inconsistent correspondences between different ICON hierarchies in the original graph are eliminated. The output of this step is a correspondence between the nodes of all the selected ICON hierarchies of the objects. FIG. 6 shows a set of handcarts places in different scenes, the clustering of the interactions in those scenes and their correspondence. We can see the interactions in each scene is clustered into three types: interactions with the ground, human and the objects on the handcart. Moreover, those different types of interactions correspond well across different scenes. Different objects in each scene are indicated using different numbers here as in FIG. 6.

In one embodiment, extracting the functional patches on each central object in each scene based on the built correspondence, further comprises: getting the interacting objects that corresponding to the nodes on the first level of each interaction context in each scene; computing the interaction regions between those interacting objects and the central object and then getting the functional patches on each central object. More specifically, the interaction region is represented by a weight assignment on all the sampled points, where the weight indicates the importance of the point to the specific interaction region, and each functional patch has a corresponding functional space, which is the empty space needed for the interacting object and central object to perform such interaction and bounded by the intersection bisector surface between the central object and interacting objects.

In one embodiment, each proto-patch consists of a set of corresponding functional patches and functional space and the functional space of the proto-patch is then defined as the intersection of all the corresponding functional spaces after aligned.

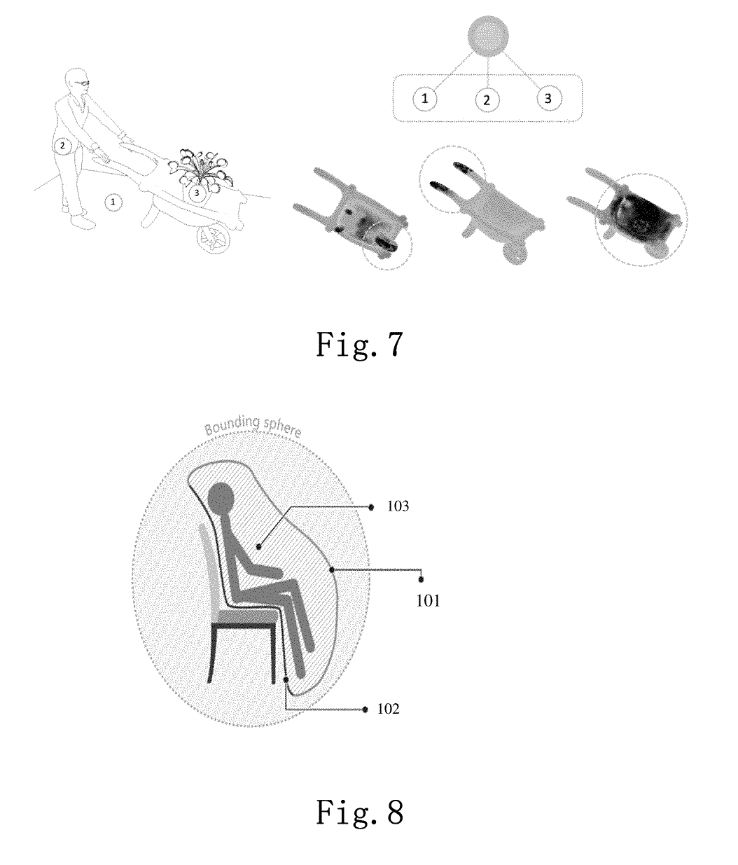

We define the functional patches based on the interaction regions of each node on the first level of each ICON hierarchy. Due to the grouping of interactions in ICON descriptors, the first-level nodes correspond to the most fundamental types of interactions, as illustrated in FIG. 6. Since a node potentially has multiple children corresponding to several interactions and IRs, we take the union of all the interacting objects corresponding to all the children of the node. Hence, we compute the IR for the interaction between the central object and this union of objects. The IRs computed with ICON are not a binary assignment of points on the surface of the object, but rather a weight assignment for all the object's points, where this weight indicates the importance of the point to the specific IR, as shown in FIG. 7. Functional patches are indicated by the dashed circles. When computing the functional properties of the patches, we take these weights into consideration. A functional patch is then described by the point weighting and properties of the corresponding IR.

In addition, we extract the functional space that surrounds each patch. To obtain this space for a patch, we first define the active scene of the central object as composed of the object itself and all the interacting objects corresponding to the interaction of the IR of the patch. Then, we first bound the active scene using a sphere. Next, we take the union between the sphere and the central object. Finally, we compute the IBS between this union and all the other interacting objects in the active scene. We use a sphere with diameter 1.2× the diagonal of the active scene's axis-aligned bounding box, to avoid splitting the functional space into multiple parts. An example of computing the functional space for the patch corresponding to the interaction between a chair and a human is illustrated in FIG. 8. In this case, we consider the chair and the human in the computation, but not the ground. The resulting IBS bounds the functional space of the patch. As shown in FIG. 8, where the central object is the chair and interacting object is the human, 101 is the IBS between the bounding sphere and the human, 102 is the IBS between the chair and the human, and 103 is the functional space needed to perform the interaction between the chair and human, which is the space surrounded by those two IBSs 101 and 102.

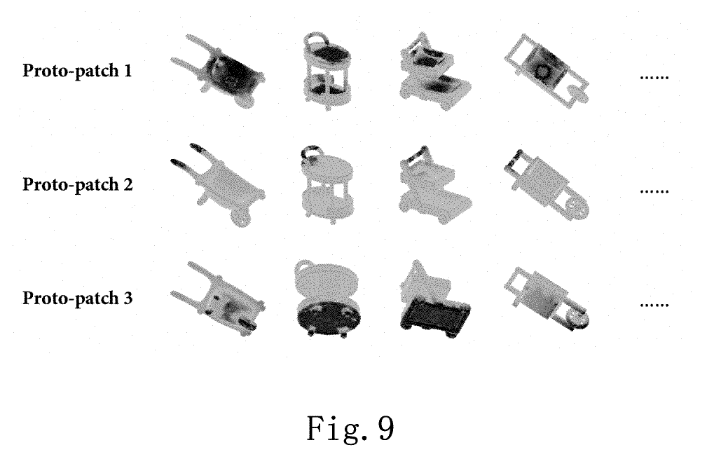

After extracting all those functional patches, a single proto-patch is defined by a set of patches in correspondence, as shown in FIG. 9. The distributions of the functionality model capture the distribution of the unary and binary properties of proto-patches in the model, respectively. There are different options for representing these distributions. In the case, since the number of training instances is relatively small compared to the dimensionality of the properties, we have opted to represent the distributions simply as sets of training samples. The probability of a new property value is derived from the distance to the nearest neighbor sample in the set. This allows us to obtain more precise estimates in the case of a small training set. If larger training sets were available, the nearest neighbor estimate could be computed with efficient spatial queries, or replaced by more scalable approaches such as regression or density-based approaches.

The functional spaces of all patches in a proto-patch are geometric entities represented as closed surfaces. To derive the functional space Sᵢ of proto-patch i, we take all the corresponding patches and align them together based on principal component analysis. A patch alignment then implies an alignment for the functional spaces, i.e., the spaces are rigidly moved according to the transformation applied to the patches. Finally, we define the functional space of the proto-patch as the intersection of all these aligned spaces. Note that when computing the unary features of each proto-patch, we already included features corresponding to the functional space. This computation of the interaction of those functional spaces is used to functionality-aware applications.

Here we give more details of the unary and binary features we used to describe the properties of the proto-patches. We assume that the input shapes are consistently upright-oriented.

We first describe the point-level unary properties. We take a small geodesic neighborhood of a point and compute the eigenvalues λ₁, λ₂, λ₃ and corresponding eigenvectors μ₁, μ₂, μ₃ of the neighborhood's covariance matrix, where λ₁≧λ₂≧λ₃≧0. We then define the features:

$$L = \frac{{λ}_{1} - {λ}_{2}}{{λ}_{1} + {λ}_{2} + {λ}_{3}} ; P = \frac{2 ( {λ}_{2} - {λ}_{3} )}{{λ}_{1} + {λ}_{2} + {λ}_{3}} ; S = \frac{3 {λ}_{3}}{{λ}_{1} + {λ}_{2} + {λ}_{3}} ;$$

which indicate how linear-, planar- and spherical-shaped the neighborhood of the point is. We also use the neighborhood to compute the mean curvature at the point and average mean curvature in the region. In addition, we compute the angle between the normal of the point and the upright direction of the shape, and angles between the covariance axes μ₁ and μ₃ and the upright vector. The projection of the point onto the upright vector provides a height feature. Finally, we collect the distance of the point to the best local reflection plane, and encode the relative position and orientation of the point in relation to the convex hull. For this descriptor, we connect a line segment from the point to the center of the shape's convex hull and record the distance of this segment and the angle of the segment with the upright vector, resulting in a 2D histogram. To capture the functional space, we record the distance from the point to the first intersection of a ray following its normal, and encode this as a 2D histogram according to the distance value and angle between the point's normal and upright vector. The distances are normalized by the bounding box diagonal of the shapes and, if there is no intersection, the distance is set to the maximum value 1.

The patch-level unary properties are then histograms capturing the distribution of the point-level properties in a patch. We use histograms composed of 10 bins, and 10×10=100 bins specifically for 2D histograms.

For the binary properties, we define two properties at the point-level: the relative orientation and relative position between pairs of points. For the orientation, we compute the angle between the normal of two points. For the position, we compute the length and the angle between the line segment defined between two points and the upright vector of the shape. The patch-level properties derived for two patches i and j are then 1D and 2D histograms, with 10 and 10×10=100 bins, respectively.

Till now, we obtained the proto-patches and their unary and binary features used to build the functionality model. However, since different unary and binary properties may be useful for capturing different functionalities, to better reflect the different characteristics of different object categories, we still need to define a set of weights to indicate the relevance of unary and binary properties in describing the functionality. So, each functionality model [symbol] also contains a set of feature combination weights [symbol] .

S107 in FIG. 1 indicates that the feature combination weights need to be optimized to get the final functionality model. To learn the weights for a model [symbol] , we define a metric learning problem: we use the functionality score to rank all the objects in the training set against [symbol] , where the training set includes objects from other categories as well. The objective of the learning is then that objects from the model's category should be ranked before objects from other categories. Specifically, let n₁ and n₂ be the number of shapes in the training set that are inside and outside the category of M, respectively. We have n₁n₂ pairwise constraints specifying that the score of a shape inside the category of [symbol] should be smaller than the score of a shape outside. We use these constraints to pose and solve a metric learning problem.

A challenge is that the score employed to learn the weights is itself a function of the feature weights [symbol] . As mentioned above, the functionality score is formulated in terms of distances between predicted patches and proto-patches of [symbol] . Due to this reason, we learn the weights in an iterative scheme. In more detail, after obtaining the initial predicted patches for each shape (which does not require weights), we learn the optimal weights by solving the metric learning described above, and then refine the predicted patches with the learned weights by solving a constrained optimization problem. We then repeat the process with the refined patches until either the functionality score or the weights converge. The details of initial prediction and patch refinement will be explained later. Once we learned the optimal property weights for a model [symbol] , they are fixed and used for functionality prediction on any input shape.

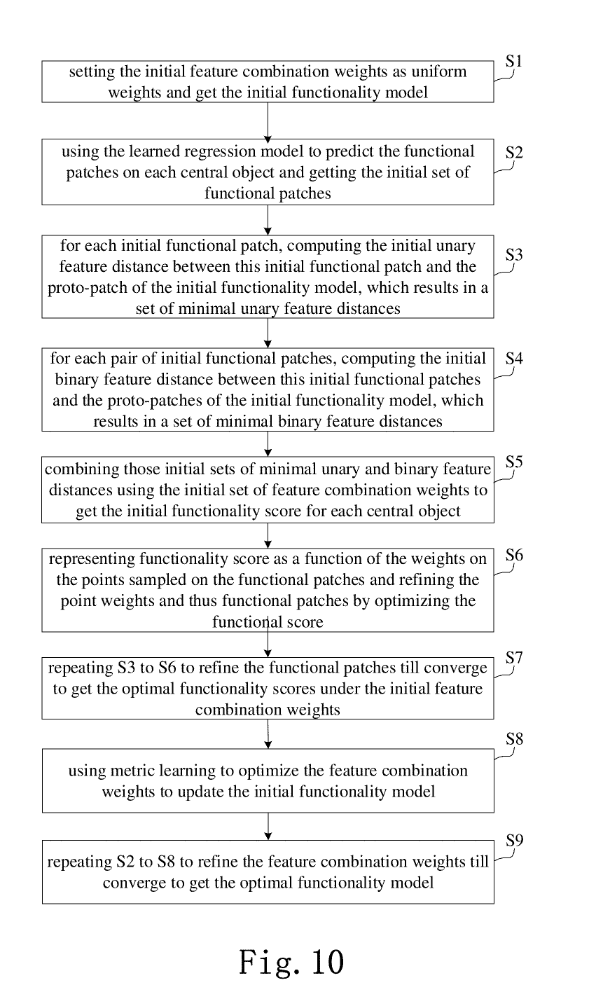

As shown in FIG. 10, In one embodiment, S107 shown in FIG. 1 comprises:

S1: Set the initial feature combination weights as uniform weights and get the initial functionality model. For example, if we have N features in total, then the initial combination weight for each feature would be 1/N.

S2: Use the learned regression model to predict the functional patches on each central object and get the initial set of functional patches.

To estimate the location of the patches and their scores efficiently, we first compute an initial guess W⁰ for the functional patches using the point-level properties only. Then, we find the nearest neighborhoods Nₖ and N_{k,l}^{b}, and optimize W to minimize [symbol] (W, [symbol] ).

More specifically, we use regression to predict the likelihood of any point in a new shape to be part of each proto-patch. In a pre-processing step, we train a random regression forest (using 30 trees) on the point-level properties for each proto-patch Pᵢ. For any given new shape, after computing the properties for the sample points, we can predict the likelihood of each point with respect to each Pᵢ. We set this as the initial W⁰.

S3: For each initial functional patch, compute the initial unary feature distance between this initial functional patch and the proto-patch of the initial functionality model, which results in a set of minimal unary feature distances.

Given a functionality model and an unknown object, we can predict whether the object supports the functionality of the model. More precisely, we can estimate the degree to which the object supports this functionality. To use the model for such a task, we first need to locate patches on the object that correspond to the proto-patches of the model. However, since the object is given in isolation without a scene context from where we could extract the patches, the strategy is to search for the patches that give the best functionality estimation according to the model. Thus, we formulate the problem as an optimization that simultaneously defines the patches and computes their functionality score.

For practical reasons, we will define a functionality distance [symbol] instead of a functionality score. The distance measures how far an object is from satisfying the functionality of a given category model [symbol] , and its values are between 0 and 1. The functionality score of a shape can then be simply defined as [symbol] =1− [symbol] .

Let us first look at the case of locating a single patch πᵢ on the unknown object, so that the patch corresponds to a specific proto-patch Pᵢ of the model. We need to define the spatial extent of πᵢ on the object and estimate how well the property values of πᵢ agree with the distributions of Pᵢ. We solve these two tasks with an iterative approach, alternating between the computation of the functionality distance from πᵢ to Pᵢ, and the refinement of the extent of πᵢ based on a gradient descent.

We represent an object as a set of n surface sample points. The shape and spatial extent of a patch πᵢ is encoded as a column vector Wᵢ of dimension n. Each entry 0≦W_{p,i}≦1 of this vector indicates how strongly point p belongs to πᵢ. Thus, in practice, the patches are a probabilistic distribution of their location, rather than discrete sets of points.

Let us assume for now that the spatial extent of a patch πᵢ is al-ready defined by Wi. To obtain a functionality distance of πᵢ to the proto-patch Pᵢ, we compute the patch-level properties of πᵢ and compare them to the properties of Pᵢ. As mentioned above, we use the nearest neighbor approach for this task. In detail, given a specific abstract property uₖ, we compute the corresponding descriptor for patch πᵢ that is defined by Wᵢ, and denoted Dᵤ_{ₖ}(Wᵢ). Next, we find its nearest neighbor in distribution u_{i,k}∈Pᵢ, denoted [symbol] (u_{i,k}). The functionality distance for this property is given by

[symbol]

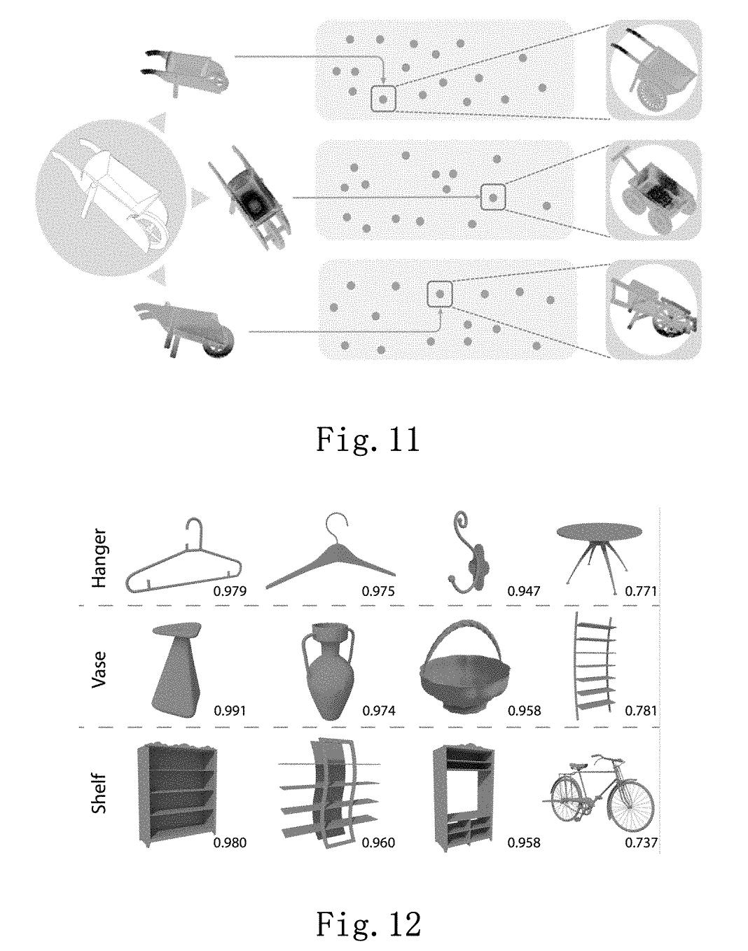

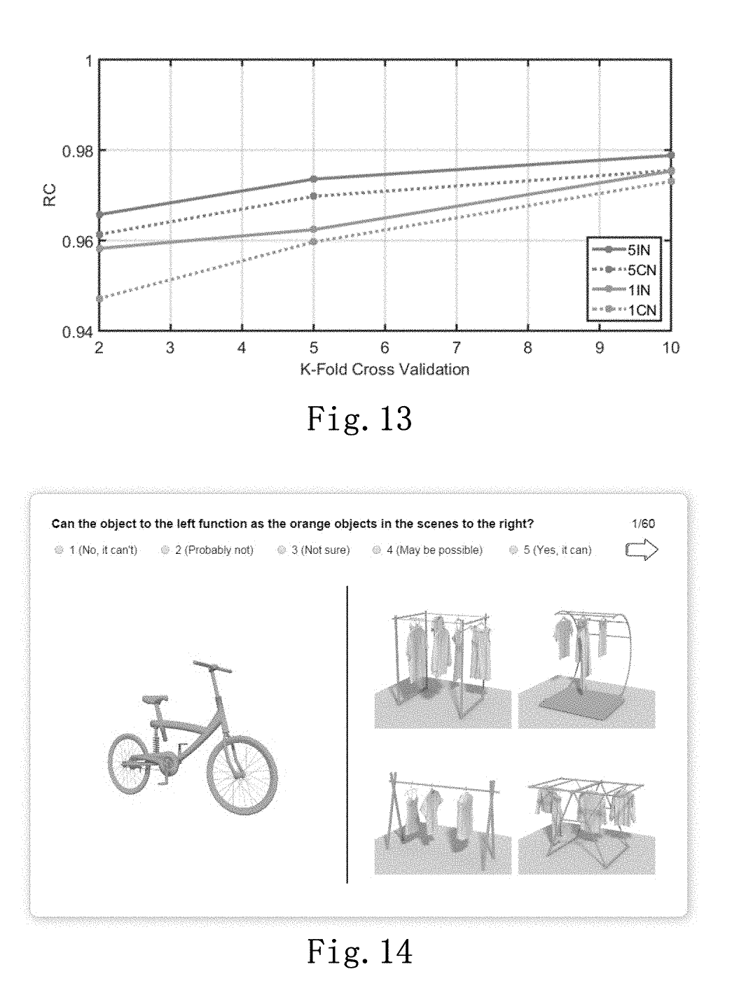

ᵤ_{ₖ}(Wᵢ,u_{i,k})=∥Dᵤ_{ₖ}(Wᵢ)− [symbol] (u_{i,k})∥_{F}²

where ∥•∥_{F}² is the Frobenius norm of a vector. This process is illustrated in FIG. 11, where the black regions indicate the functional patches. In practice, we consider multiple nearest neighbors for robustness, implying that the functionality distance is a sum of distances to all nearest neighbors, i.e., we have a term like the right-hand of the equation above for each neighbor. However, to simplify the notation of subsequent formulas, we omit this additional sum.

When considering multiple properties, we assume statistical independence among the properties and formulate the functionality distance for patch Wᵢ as the sum of all property distances:

$${𝒟}_{u} ( {W}_{i} , {P}_{i} ) = {\sum }_{{u}_{k}}^{ } {α}_{k}^{u} {‖ {D}_{{u}_{k}} ( {W}_{i} ) = 𝒩 ( {U}_{i , k} ) ‖}_{F}^{2}$$

where αₖ^{u} is the weight learned for property uₖ in [symbol] . [symbol] ᵤ(Wᵢ, Pᵢ) then measures how close the patch defined by Wᵢ is to supporting interactions like the ones supported by proto-patch Pᵢ.

Now, given the nearest neighbors for patch πᵢ, we are able to refine the location and extent of the patch defined by Wᵢ by performing a gradient descent of the distance function. This process is repeated iteratively similar to an expectation-maximization approach: starting with some initial guess for Wᵢ, we locate its nearest neighbors, compute the functionality distance, and then refine Wᵢ. The iterations stop when the change in the functionality distance is smaller than a given threshold.

S4: For each pair of initial functional patches, compute the initial binary feature distance between this initial functional patches and the proto-patches of the initial functionality model, which results in a set of minimal binary feature distances.

Next, we explain how this formulation can be extended to include multiple patches as well as the binary properties of the model [symbol] .

We represent multiple patches on a shape by a matrix W of dimensions n×m, where m is the number of proto-patches in the model [symbol] of the given category. A column Wᵢ of this matrix represents a single patch πᵢ as defined above. We formulate the distance measure that considers multiple patches and binary properties between them as:

[symbol]

(W, [symbol] )= [symbol] ᵤ(W, [symbol] )+ [symbol] _{b}(W, [symbol] )

where [symbol] ᵤ and [symbol] _{b} are distance measures that consider the distributions of unary and binary properties of [symbol] , respectively.

We use the functionality distance of a patch to formulate a term that considers the unary properties of all the proto-patches in the model:

$${𝒟}_{u} ( W , ℳ ) = {\sum }_{i}^{ } {\sum }_{{u}_{i , k}}^{ } {α}_{k}^{u} {𝒟}_{{u}_{k}} ( {W}_{i} , {u}_{i , k} ) = {\sum }_{i}^{ } {\sum }_{{u}_{i , k}}^{ } {α}_{k}^{u} {‖ {D}_{{u}_{k}} ( {W}_{i} ) = 𝒩 ( {U}_{i , k} ) ‖}_{F}^{2}$$

As mentioned above, the patch-level descriptors for patches are histograms of point-level properties. Since we optimize the objective with an iterative scheme that can change the patches πᵢ in each iteration, it would appear that we need to recompute the histograms for each patch at every iteration. However, for each sample point on the shape, the properties are immutable. Hence, we decouple the point-level property values from the histogram bins by formulating the patch-level descriptors as Dᵤ_{ₖ}(Wᵢ)=BₖWᵢ, where Bₖ∈{0, 1}ⁿ^{ₖ}^{^{u}}^{×n} is a constant logical matrix that indicates the bin of each sample point for property uₖ. The dimension nₖ^{u} is the number of bins for property uₖ, and n is the number of sample points of the shape. [symbol] ₖ is computed once, based on the point-level properties of each sample. This speeds up the optimization as we do not need to update the matrices [symbol] ₖ at each iteration, and only update the Wᵢ's, that represent each patch πᵢ.

The unary distance measure thus can be written in matrix form as

$${𝒟}_{u} ( W , ℳ ) = {\sum }_{{u}_{k}}^{ } {α}_{k}^{u} {‖ {B}_{k} W - {𝒩}_{k} ‖}_{F}^{2}$$

$$where {𝒩}_{k} = [ {𝒩}_{k} ( {u}_{1 , k} ) , {𝒩}_{k} ( {u}_{2 , k} ) , … , {𝒩}_{k} ( {u}_{m , k} ) ] .$$

Similarly, the binary distance measure can be written as

$$\begin{matrix}{𝒟}_{b} ( W , ℳ ) = {\sum }_{i , j}^{ } {\sum }_{{b}_{i , j , k}}^{ } {α}_{k}^{b} {𝒟}_{{b}_{k}} ( {W}_{i} , {W}_{j} , {b}_{i , j , k} ) \\ = {\sum }_{i , j}^{ } {\sum }_{{b}_{i , j , k}}^{ } {α}_{k}^{b} {\sum }_{l = 1}^{{n}_{k}^{b}} {( {W}_{i}^{T} {B}_{k , l}^{b} {W}_{j} - {𝒩 ( {b}_{i , j , k} )}_{l} )}^{2} \\ = {\sum }_{{b}_{k}}^{ } {\sum }_{l = 1}^{{n}_{k}^{b}} {α}_{k}^{b} {\sum }_{i , j}^{ } {( {W}_{i}^{T} {B}_{k , l}^{b} {W}_{j} - {𝒩 ( {b}_{i , j , k} )}_{l} )}^{2} \\ = {\sum }_{{b}_{k}}^{ } {\sum }_{l = 1}^{{n}_{k}^{b}} {α}_{k}^{b} {‖ {W}^{T} {B}_{k , l}^{b} W - {N}_{k , l}^{b} ‖}_{F}^{2}\end{matrix}$$

where αₖ^{b} is the weight learned for property bₖ in [symbol] , B_{k,l}^{b}∈{0, 1}^{n×n} is a logical matrix that indicates whether a pair of samples contributes to bin [symbol] of the binary descriptor [symbol] , nₖ^{b} is the number of bins for property k, and N_{k,l}^{b} =[ [symbol] (b_{i,j,k})ₗ; ∀i, j]∈R^{m×m}, where [symbol] (b_{i,j,k})ₗ is the l-th bin of the histogram [symbol] (b_{i,j,k}). Note that both [symbol] _{k,l}^{b} and N_{k,l}^{b} are symmetric.

S5: Combine those initial sets of minimal unary and binary feature distances using the initial set of feature combination weights to get the initial functionality score for each central object: [symbol] (W, [symbol] )= [symbol] _{μ}(W, [symbol] )+ [symbol] _{b}(W, [symbol] ).

S6: The functionality score can be represented as a function of the weights on the points sampled on the functional patches. By optimizing the functionality score, points weights are refined and thus functional patches.

We find the nearest neighbors of the predicted patches for every property in the proto-patch, and refine [symbol] by performing a gradient descent to optimize [symbol] (W, [symbol] ). We set two constraints on [symbol] to obtain a meaningful solution: W≧0 and ∥Wᵢ∥₁=1. We employ a limited-memory projected quasi-Newton algorithm (PQN) [10] to solve this constrained optimization problem since it is efficient for large-scale optimization with simple constraints. To apply PQN, we need the gradient of the objective function. Although the gradient can become negative, the optimization uses a projection onto a simplex to ensure that the weights satisfy the constraints. The optimization stops when the change in the objective function is smaller than 0.001.

The result of the optimization is a set of patches that are located on the input shape and represented by W. Each patch Wᵢ corresponds to proto-patch Pᵢ in the model. Using these patches, we obtain two types of functionality distance: (i) The global functionality distance of the object, that estimates how well the object supports the functionality of the model; and, (ii) The functionality distance of each patch, which is of a local nature and quantifies how well Wi supports the interactions that proto-patch Pᵢ supports. This gives an indication of how each portion of the object contributes to the functionality of the whole shape.

S7: Repeat S3 to S6 to refine the functional patches till converge to get the optimal functionality scores under the initial feature combination weights;

S8: Use metric learning to optimize the feature combination weights, to update the initial functionality model;

S9: Repeat S2 to S8 to refine the feature combination weights till converge to get the optimal functionality model.

Comparing to the existing model-based functionality analysis method, a key difference of this invention is that we build the connection between shape geometry and functionality in a more specific way, which results in the functionality model. Moreover, with the new feature of functional patch localization, more functionality-aware applications like functional object enhancement are more possible, instead of working on the functionality recognition and similarity measure only. The method analyzes objects at the point and patch level; the objects do not need to be segmented and no prior knowledge is needed.

Comparing to the existing agent-based functionality analysis method, a key difference is that this invention can deal with more general object-to-object interactions instead of constraining the interacting object to some specific agent. On a more conceptual level, how an object functions is not always well reflected by interactions with human poses. For example, consider a drying rack with hanging laundry; there is no human interaction involved. Even if looking only at human poses, one may have a hard time discriminating between certain objects, e.g., a hook and a vase, since a human may hold these objects with a similar pose. Last but not the least, even if an object is designed to be directly used by humans, human poses alone cannot always distinguish its functionality from others. For example, a human can carry a backpack while sitting, standing or walking. The specific pose of the human does not allow us to infer the functionality of the backpack. The focus is on the interactions themselves instead of the interacting objects.

Here we demonstrate potential applications enabled by the functionality model.

1. Functionality Similarity

We derive a measure to assess the similarity of the functionality of two objects. Given a functionality model and an unknown object, we can verify how well the object supports the functionality of a category. Intuitively, if two objects support similar types of functionalities, then they should be functionally similar, such as a handcart that supports similar interactions as a stroller. However, the converse is not necessarily true: if two objects do not support a certain functionality, it does not necessarily imply that the objects are functionally similar. For example, the fact that both a table and a backpack cannot be used as a bicycle does not imply that they are functionally similar. Thus, when comparing the functionality of two objects, we should take into consideration only the functionalities that each object likely supports. To perform such a comparison, we decide whether an object supports a certain functionality only if its functionality score, computed with the corresponding model, is above a threshold.

More specifically, since we learn 15 different functionality models based on the dataset, we compute 15 functionality scores for any unknown shape. We concatenate all the scores into a vector of functional similarity Fₛ=[f₁^{S}, f₂^{S}, . . . , fₙ^{S}] for shape S, where n=15. We then determine whether the shape supports a given functionality by verifying if the corresponding entry in this vector is above a threshold. We compute the thresholds for each category based on the shapes inside the category using the following procedure. We perform a leave-one-out cross validation, where each shape is left out of the model learning so that we obtain its unbiased functionality score. Next, we compute a histogram of the predicted scores of all the shapes in the category. We then fit a Beta distribution to the histogram and set the threshold tᵢ, for category i, as the point where the inverse cumulative distribution function value is 0.01.

The functionality distance between two shapes is then defined as

$$𝒟 ( {S}_{1} , {S}_{2} ) = {\sum }_{i = 1}^{n} φ ( {f}_{i}^{{S}_{1}} , {f}_{i}^{{S}_{2}} , {t}_{i} ) / \vert J \vert$$

$$where$$

$$φ ( x , y , t ) = \{ \begin{matrix}{‖ x - y ‖}_{2} & max ( x , y ) \geq t , \\ 0 , & otherwise\end{matrix} .$$

The function φ considers a functionality only if either S₁ or S₂ supports it, while J={i| min (fᵢ^{S}^{₁}, fᵢ^{S}^{₂})≧tᵢ, i=1, . . . , n} is the set of functionalities that are supported by both S₁ and S₂.

2. Detection of Multiple Functionalities

A chair may serve multiple functions, depending on its pose. To discover such multiple functionalities for a given object using the functionality models learned from the dataset, we sample various poses of the object. For each functionality model learned of a category, the object pose that achieves the highest functionality score is selected. Moreover, based on patch correspondence inferred from the prediction process, we can also scale the object so that it can replace an object belonging to a different category, in its contextual scene.

We also test the functionality model on 15 classes of objects, where each class has 10-50 central objects, with 608 objects and their scenes in total.

### 1. Functionality Prediction Results

We learned the functionality model for 15 classes of objects and then predict the corresponding functionality for any given new shapes. FIG. 12 shows some examples of the prediction results. We can see that the method can recognize the functionality of hangers, vases and shelves accurately. Moreover, the method can even find that objects from other categories can support similar functionality, for example, the wall hanger shown in the first row can be used as the hanger on the left for hanging clothes, the basket shown in the second row can be used as vases, and the TV-bench shown in the third row can be used as shelves. For shapes with very different functionality, the method will directly give low scores, for example, bicycle cannot really support the functionality of the shelves.

2. Functionality Prediction Evaluation

There are several parameters in the learning scheme, so to evaluate the accuracy and robustness of the learned models, we tune the parameters to see how the results will change. As shown in FIG. 3, the method has higher prediction accuracy under different parameters, with racking consistency (RC) always over 0.94.

3. User Study

To demonstrate more conclusively that we discover the functionality of shapes, i.e., the functional aspects of shapes that can be derived from the geometry of their interactions, we conducted a small user study with the goal of verifying the agreement of the model with human perception. Specifically, we verified the agreement of the functionality scores with scores derived from human-given data. Example queries are shown in FIG. 14. We collected 60 queries from each user; we had 72 users.

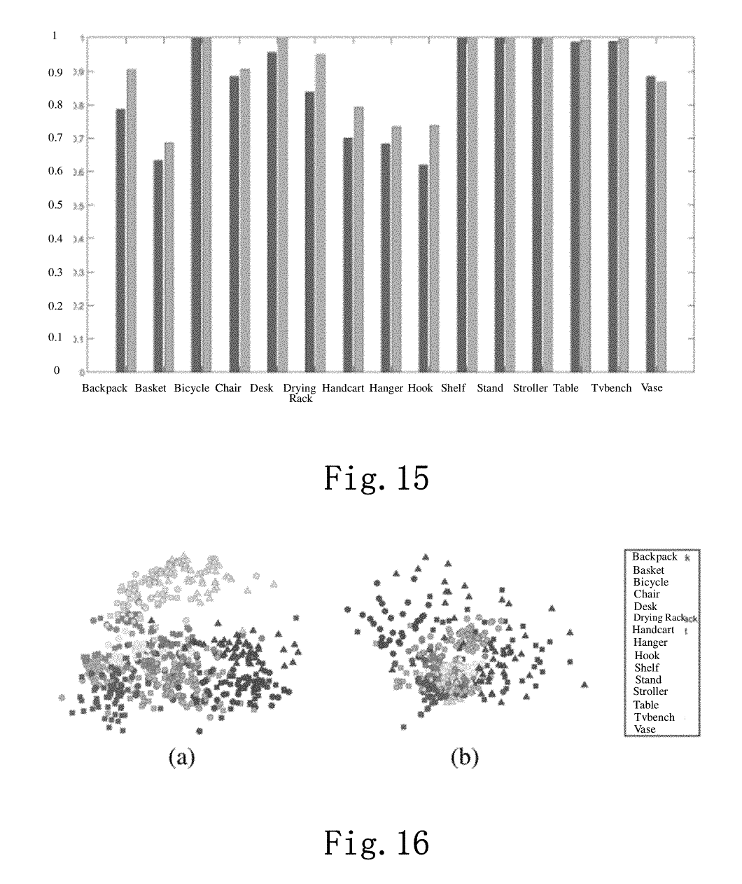

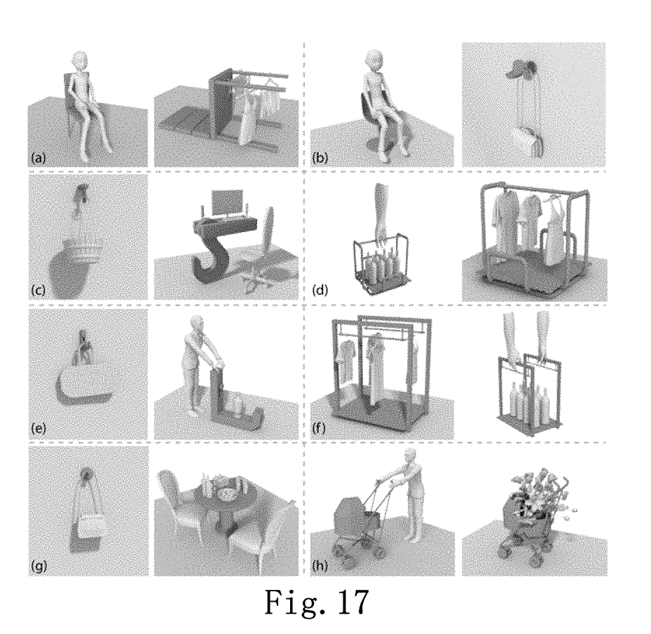

FIG. 15 shows the agreement for each category, where the red bars denote the agreement estimated on all the collected data, while the blue bars denote the agreement after cleaning some of the user data. We see in the plot that, users agree at least 80% with the model for 12 out of 15 categories.

4. Functionality Similarity Evaluation

In FIG. 16, we show a 2D embedding of all the shapes in the dataset obtained with multi-dimensional scaling, where the Euclidean distance between two points approximates the functionality distance between two shapes. We compare it to an embedding obtained with the similarity of light field descriptors of the shapes. Note how, in the embedding, the shapes are well distributed into separate clusters, while the clusters in the light field embedding have significant overlap. Moreover, the overlaps in the embedding of the distance occur mostly for the categories that have functional correlation.

5. Multi-Function Detection

FIG. 16 shows a set of examples for multi-function detection. For each pair, we show on the left the original object in a contextual scene to provide a contrast; the scene context is not used in the prediction process. On the right, we show the scaled object serving a new function. We believe that this type of exploration can potentially inspire users to design objects that serve a desired functionality while having a surprising new geometry.

Based on the same idea of the functionality analysis method explained above, the present invention further provides a functionality analysis apparatus for given 3D objects. Since the core technical part of the functionality analysis apparatus is the same as the functionality analysis method explained above, we will omit some repeated parts in the following explanation.

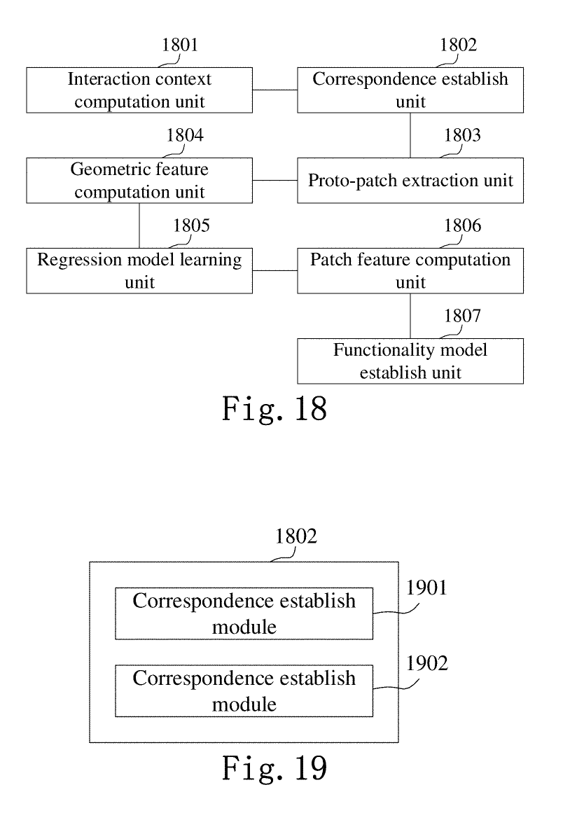

FIG. 18 shows a flowchart of the developed functionality analysis apparatus in an embodiment of the present invention. As shown in FIG. 18, this functionality analysis apparatus for given 3D shapes comprises:

a interaction context computation unit 1801 configured to compute the shape descriptor called interaction context for the central object given in each scene, where the interaction context is a hierarchical structure which encodes the interaction bisector surface and interaction region between the central object and any interacting object and the central object needs to be put in a scene to compute the corresponding interaction context;

a correspondence establish unit 1802 configured to build the correspondence among those scenes based on the computed interaction context;

a proto-patch extraction unit 1803 configured to extract the functional patches on each central object in each scene based on the built correspondence, and forming a set of proto-patches which is a key component of the functionality model;

a geometric feature computation unit 1804 configured to sample a set of points on each consisting functional patch for each proto-patch and compute a set of geometric features;

a regression model learning unit 1805 configured to learn a regression model from the geometric features on sample points to their weights for each proto-patch;

a patch feature computation unit 1806 configured to compute the unary and binary features of each functional patch, where the unary features encode the geometric feature of each single functional patch while the binary feature encode the structural relation between any two functional patches; and

a functionality model establish unit 1807 configured to refine the feature combination weights to get the final functionality mode, where the feature combination weights are used to combine those unary and binary features.

As shown in FIG. 19, correspondence establish unit 1802 further comprises:

the first correspondence establish module 1901 configured to get the correspondence between each pair of scenes based on the subtree isomorphism between the interaction contexts of those two scenes;

the second correspondence establish module 1902 configured to build a correspondence across the whole set of scenes by selecting the optimal path from those binary correspondences between all pairs of scenes.

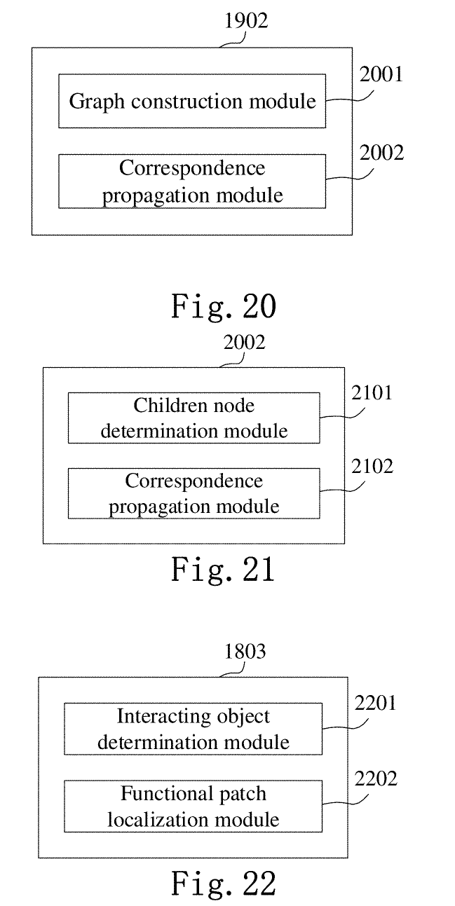

As shown in FIG. 20, the second correspondence establish module 1902 further comprises:

a graph construction module 2001 configured to build a graph for the given scene dataset, where each node corresponds to the central object of one scene and each edge encodes the distance between the interaction contexts of those two central objects corresponding to the two connecting nodes; and

a correspondence propagation module 2002 configured to find the minimal spanning tree of the graph mentioned above, and then propagate the correspondence between each pair of scenes to the whole set based on the spanning tree.

As shown in FIG. 21, the correspondence propagation module 2002 further comprises:

a children node determination module 2101 configured to randomly pick one node in the scene graph as the root node, and find the nodes that directly connect to the root to determine the initial set of correspondences; and

a correspondence propagation module 2102 configured to recursively propagate the already determined correspondence between the parent node and children nodes to the next level of children nodes using Breadth-First-Search method.

As shown in FIG. 22, the proto-patch extraction unit 1803 further comprises:

an interacting object determination module 2201 configured to get the interacting objects that corresponding to the nodes on the first level of each interaction context in each scene; and

a functional patch localization module 2202 configured to compute the interaction regions between those interacting objects and the central object and then get the functional patches on each central object.

In one embodiment, the interaction region is represented by a weight assignment on all the sampled points where the weight indicates the importance of the point to the specific interaction region.

In one embodiment, each functional patch has a corresponding functional space, which is the empty space needed for the interacting object and central object to perform such interaction and bounded by the intersection bisector surface between the central object and interacting objects.

In one embodiment, each proto-patch consists of a set of corresponding functional patches and functional space. The functional space of the proto-patch is then defined as the intersection of all the corresponding functional spaces after aligned.

In one embodiment, the geometric features computed for each sample point include how linear-, planar- and spherical-shaped the neighborhood of the point is, the angle between the normal of the point and the upright direction of the shape, angles between the covariance axes and the upright vector, height feature, the relation between the point and the shape's convex hull, ambient occlusion.

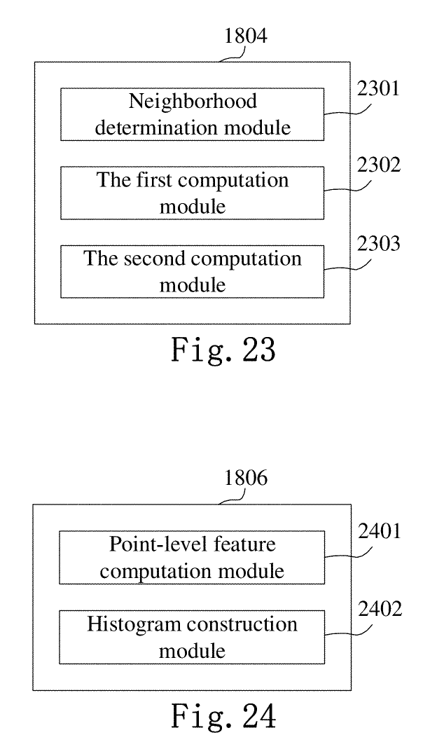

In one embodiment, as shown in FIG. 23, the geometric feature computation unit 1804 further comprises:

a neighborhood determination module 2301 configured to take a small geodesic neighborhood for each sampled point;

the first computation module 2302 configured to compute the eigenvalues λ₁, λ₂, λ₃ and corresponding eigenvectors μ₁, μ₂, μ₃ of the neighborhood's covariance matrix, where λ₁≧λ₂≧λ₃≧0; and

the second computation module 2303 configured to define the features which indicate how linear (L)-, planar (P)- and spherical (S)-shaped the neighborhood of the point is respectively as:

$$L = \frac{{λ}_{1} - {λ}_{2}}{{λ}_{1} + {λ}_{2} + {λ}_{3}} ; P = \frac{2 ( {λ}_{2} - {λ}_{3} )}{{λ}_{1} + {λ}_{2} + {λ}_{3}} ; S = \frac{3 {λ}_{3}}{{λ}_{1} + {λ}_{2} + {λ}_{3}} .$$

In one embodiment, compute the relation between the point and the shape's convex hull, which means connect a line segment from the point to the center of the shape's convex hull and record the length of this segment and the angle of the segment with the upright vector.

In one embodiment, the patch feature computation module is used to compute the unary features of each functional patch based on the geometric features, which means to compute the point-level geometric feature first and then build a histogram capturing the distribution of the point-level features in such patch.

In one embodiment, as shown in FIG. 24, the patch feature computation module 1806 for binary feature further comprises:

a point-level feature computation module 2401 configured to connect a line segment from a sampled point on one patch to any sampled point on the other patch for each pair of functional patches of any central object in a scene, and compute the length of this segment and the angle of the segment with the upright vector; and

a histogram construction module 2402 configured to build a histogram capturing the distribution of the segment lengths and angles computed from all the pairs of sampled points and get the final binary feature.

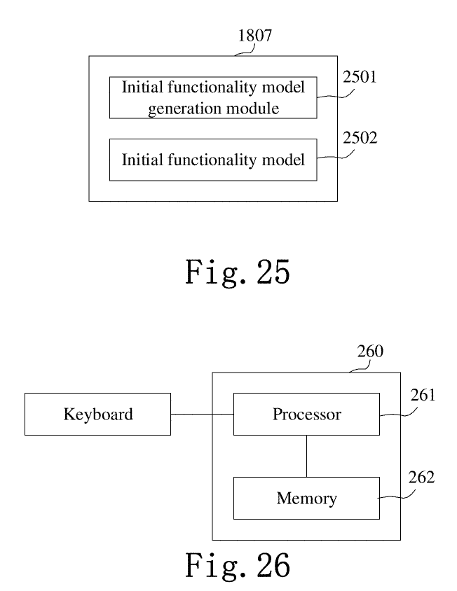

In one embodiment, as shown in FIG. 25, the functionality model establish unit 1807 further comprises:

an initial functionality model generation module 2501 configured to set the initial feature combination weights as uniform weights and get the initial functionality model 2502; and

an initial functional patch localization module 2503, which uses the learned regression model to predict the functional patches on each central object and gets the initial set of functional patches;

a unary feature computation module 2504 configured to compute the initial unary feature distance between each initial functional patch and the proto-patch of the initial functionality model, resulting in a set of minimal unary feature distances;

a binary feature computation module 2505 configured to compute the initial binary feature distance between each pair of initial functional patches and the proto-patches of the initial functionality model, which results in a set of minimal binary feature distances;

a functionality score computation module 2506 configured to combine those initial sets of minimal unary and binary feature distances using the initial set of feature combination weights to get the initial functionality score for each central object;

a functional patch optimization module 2507 configured to represent the functionality score as a function of the weights on the points sampled on the functional patches and refine points weights and thus functional patches by optimizing the functionality score;

a functionality score optimization module 2508 configured to repeat S3 to S6 to refine the functional patches till converge to get the optimal functionality scores under the initial feature combination weights;

a functionality model optimization module 2509, which uses metric learning to optimize the feature combination weights, to update the initial functionality model; and

a functionality model finalization module 2510 configured to repeat S2 to S8 to refine the feature combination weights till converge to get the optimal functionality model.

The embodiments of the present invention further provide a computer readable storage medium containing computer readable instructions which when being executed, the computer readable instructions enable a processor to perform at least the operations of:

computing interaction context for the central object given in each scene, where the interaction context is a hierarchical structure which encodes the interaction bisector surface and interaction region between the central object and any interacting object, and the central object needs to be put in a scene to compute the corresponding interaction context;

building the correspondence among those scenes based on the computed interaction context;

extracting the functional patches on each central object in each scene based on the built correspondence, and forming a set of proto-patches which is a key component of the functionality model;

sampling a set of points on each consisting functional patch for each proto-patch and computing a set of geometric features;

learning a regression model from the geometric features on sample points to their weights for each proto-patch;

computing the unary and binary features of each functional patch, where the unary features encode the geometric feature of each single functional patch while the binary feature encode the structural relation between any two functional patches; and

refining the feature combination weights to get the final functionality model, where the feature combination weights are used to combine those unary and binary features.

In one embodiment, the computer readable instructions enable a processor to build the correspondence among those scenes based on the computed interaction context, further comprising:

getting the correspondence between each pair of scenes based on the subtree isomorphism between the interaction contexts of those two scenes; and

building a correspondence across the whole set of scenes by selecting the optimal path from those binary correspondences between all pairs of scenes.

In one embodiment, the computer readable instructions enable a processor to build a correspondence across the whole set by selecting the optimal path from those binary correspondences between all pairs of scenes, further comprising:

building a graph for the given scene dataset, where each node corresponds to the central object of one scene and each edge encodes the distance between the interaction contexts of those two central objects corresponding to the two connecting nodes; and

finding the minimal spanning tree of the graph mentioned above, and then expanding the correspondence between each pair of scenes to the whole set based on the spanning tree.

In one embodiment, the computer readable instructions enable a processor to expand the correspondence between each pair of scenes to the whole set based on the spanning tree, further comprising:

randomly picking one node in the scene graph as the root node, and finding the nodes that directly connect to the root to determine the initial set of correspondences; and

using Breadth-First-Search method to recursively propagate the already determined correspondence between the parent node and children nodes to the next level of children nodes.

In one embodiment, the computer readable instructions enable a processor to extract the functional patches on each central object in each scene based on the built correspondence, further comprising:

getting the interacting objects that corresponding to the nodes on the first level of each interaction context in each scene; and

computing the interaction regions between those interacting objects and the central object and then getting the functional patches on each central object.

In one embodiment, the interaction region is represented by a weight assignment on all the sampled points where the weight indicates the importance of the point to the specific interaction region.

In one embodiment, each functional patch has a corresponding functional space, which is the empty space needed for the interacting object and central object to perform such interaction and bounded by the intersection bisector surface between the central object and interacting objects.

In one embodiment, each proto-patch consists of a set of corresponding functional patches and functional space and the functional space of the proto-patch is then defined as the intersection of all the corresponding functional spaces after aligned.

In one embodiment, the geometric features computed for each sample point include how linear-, planar- and spherical-shaped the neighborhood of the point is, the angle between the normal of the point and the upright direction of the shape, angles between the covariance axes and the upright vector, height feature, the relation between the point and the shape's convex hull, and ambient occlusion.

In one embodiment, the computer readable instructions enable a processor to compute how linear-, planar- and spherical-shaped the neighborhood of the point is, further comprising:

taking a small geodesic neighborhood of each sampled point on the given object;

computing the eigenvalues λ₁, λ₂, λ₃ and corresponding eigenvectors μ₁, μ₂, μ₃ of the neighborhood's covariance matrix, where λ₁≧λ₂≧λ₃≧0; and
defining the features which indicate how linear (L)-, planar (P)- and spherical (S)-shaped the neighborhood of the point is respectively as:

$$L = \frac{{λ}_{1} - {λ}_{2}}{{λ}_{1} + {λ}_{2} + {λ}_{3}} ; P = \frac{2 ( {λ}_{2} - {λ}_{3} )}{{λ}_{1} + {λ}_{2} + {λ}_{3}} ; S = \frac{3 {λ}_{3}}{{λ}_{1} + {λ}_{2} + {λ}_{3}} .$$

In one embodiment, computing the relation between the point and the shape's convex hull further comprising: connecting a line segment from the point to the center of the shape's convex hull and recording the length of this segment and the angle of the segment with the upright vector.

In one embodiment, computing the unary features of each functional patch based on the geometric features further comprising: computing the point-level geometric feature first and then building a histogram capturing the distribution of the point-level features in such patch.

In one embodiment, the computer readable instructions enable a processor to compute the binary features of each pair of functional patches, further comprising:

for each pair of functional patches of any central object in a scene, connecting a line segment from a sampled point on one patch to any sampled point on the other patch, and computing the length of this segment and the angle of the segment with the upright vector; and

building a histogram capturing the distribution of the segment lengths and angles computed from all the pairs of sampled points.

In one embodiment, the computer readable instructions enable a processor to refine the feature combination weights to get the final functionality model, further comprising:

S1: setting the initial feature combination weights as uniform weights and getting the initial functionality model;

S2: using the learned regression model to predict the functional patches on each central object and getting the initial set of functional patches;

S3: for each initial functional patch, computing the initial unary feature distance between this initial functional patch and the proto-patch of the initial functionality model, which results in a set of minimal unary feature distances;

S4: for each pair of initial functional patches, computing the initial binary feature distance between this initial functional patches and the proto-patches of the initial functionality model, which results in a set of minimal binary feature distances;

S5: combining those initial sets of minimal unary and binary feature distances using the initial set of feature combination weights to get the initial functionality score for each central object;

S6: representing the functionality score can as a function of the weights on the points sampled on the functional patches and refining the points weights and thus functional patches by optimizing the functionality score;

S7: repeating S3 to S6 to refine the functional patches till converge to get the optimal functionality scores under the initial feature combination weights;

S8: using metric learning to optimize the feature combination weights to update the initial functionality model; and

S9: repeating S2 to S8 to refine the feature combination weights till converge to get the optimal functionality model.

The embodiments of the present invention further provide a device as shown in FIG. 26, comprising:

a processor 261; and

a memory 262 for computer readable instructions, which when being executed, enable the processor to perform the operations of:

computing interaction context for the central object given in each scene, where the interaction context is a hierarchical structure which encodes the interaction bisector surface and interaction region between the central object and any interacting object, and the central object needs to be put in a scene to compute the corresponding interaction context;

building the correspondence among those scenes based on the computed interaction context;

extracting the functional patches on each central object in each scene based on the built correspondence, and forming a set of proto-patches which is a key component of the functionality model;

sampling a set of points on each consisting functional patch for each proto-patch and computing a set of geometric features;

learning a regression model from the geometric features on sample points to their weights for each proto-patch;

computing the unary and binary features of each functional patch, where the unary features encode the geometric feature of each single functional patch while the binary feature encode the structural relation between any two functional patches; and

refining the feature combination weights to get the final functionality model, where the feature combination weights are used to combine those unary and binary features.

In one embodiment, the computer readable instructions enable a processor to build the correspondence among those scenes based on the computed interaction context, further comprising:

getting the correspondence between each pair of scenes based on the subtree isomorphism between the interaction contexts of those two scenes; and

building a correspondence across the whole set of scenes by selecting the optimal path from those binary correspondences between all pairs of scenes.

In one embodiment, the computer readable instructions enable a processor to build a correspondence across the whole set by selecting the optimal path from those binary correspondences between all pairs of scenes, further comprising:

building a graph for the given scene dataset, where each node corresponds to the central object of one scene and each edge encodes the distance between the interaction contexts of those two central objects corresponding to the two connecting nodes; and

finding the minimal spanning tree of the graph mentioned above, and then expanding the correspondence between each pair of scenes to the whole set based on the spanning tree.

In one embodiment, the computer readable instructions enable a processor to expand the correspondence between each pair of scenes to the whole set based on the spanning tree, further comprising:

randomly picking one node in the scene graph as the root node, and finding the nodes that directly connect to the root to determine the initial set of correspondences; and

using Breadth-First-Search method to recursively propagate the already determined correspondence between the parent node and children nodes to the next level of children nodes.

In one embodiment, the computer readable instructions enable a processor to extract the functional patches on each central object in each scene based on the built correspondence, further comprising:

getting the interacting objects that corresponding to the nodes on the first level of each interaction context in each scene; and

computing the interaction regions between those interacting objects and the central object and then getting the functional patches on each central object.

In one embodiment, the interaction region is represented by a weight assignment on all the sampled points, where the weight indicates the importance of the point to the specific interaction region.

In one embodiment, each functional patch has a corresponding functional space, which is the empty space needed for the interacting object and central object to perform such interaction and bounded by the intersection bisector surface between the central object and interacting objects.

In one embodiment, each proto-patch consists of a set of corresponding functional patches and functional space and the functional space of the proto-patch is then defined as the intersection of all the corresponding functional spaces after aligned.

In one embodiment, the geometric features computed for each sample point include how linear-, planar- and spherical-shaped the neighborhood of the point is, the angle between the normal of the point and the upright direction of the shape, angles between the covariance axes and the upright vector, height feature, the relation between the point and the shape's convex hull, and ambient occlusion.

In one embodiment, the computer readable instructions enable a processor to compute how linear-, planar- and spherical-shaped the neighborhood of the point is, further comprising:

taking a small geodesic neighborhood of each sampled point on the given object;

computing the eigenvalues λ₁, λ₂, λ₃ and corresponding eigenvectors μ₁, μ₂, μ₃ of the neighborhood's covariance matrix, where λ₁≧λ₂≧λ₃≧0; and
defining the features which indicate how linear (L)-, planar (P)- and spherical (S)-shaped the neighborhood of the point is respectively as:

$$L = \frac{{λ}_{1} - {λ}_{2}}{{λ}_{1} + {λ}_{2} + {λ}_{3}} ; P = \frac{2 ( {λ}_{2} - {λ}_{3} )}{{λ}_{1} + {λ}_{2} + {λ}_{3}} ; S = \frac{3 {λ}_{3}}{{λ}_{1} + {λ}_{2} + {λ}_{3}} .$$

In one embodiment, computing the relation between the point and the shape's convex hull further comprises: connecting a line segment from the point to the center of the shape's convex hull and recording the length of this segment and the angle of the segment with the upright vector.

In one embodiment, computing the unary features of each functional patch based on the geometric features further comprises: computing the point-level geometric feature first and then building a histogram capturing the distribution of the point-level features in such patch.

In one embodiment, the computer readable instructions enable a processor to compute the binary features of each pair of functional patches, further comprising:

for each pair of functional patches of any central object in a scene, connecting a line segment from a sampled point on one patch to any sampled point on the other patch, and computing the length of this segment and the angle of the segment with the upright vector; and

building a histogram capturing the distribution of the segment lengths and angles computed from all the pairs of sampled points.

In one embodiment, the computer readable instructions enable a processor to refine the feature combination weights to get the final functionality model, further comprising:

S1: setting the initial feature combination weights as uniform weights and getting the initial functionality model;

S2: using the learned regression model to predict the functional patches on each central object and getting the initial set of functional patches;

S3: for each initial functional patch, computing the initial unary feature distance between this initial functional patch and the proto-patch of the initial functionality model, which results in a set of minimal unary feature distances;

S4: for each pair of initial functional patches, computing the initial binary feature distance between this initial functional patches and the proto-patches of the initial functionality model, which results in a set of minimal binary feature distances;

S5: combining those initial sets of minimal unary and binary feature distances using the initial set of feature combination weights to get the initial functionality score for each central object;

S6: representing the functionality score can as a function of the weights on the points sampled on the functional patches and refining the points weights and thus functional patches by optimizing the functionality score;

S7: repeating S3 to S6 to refine the functional patches till converge to get the optimal functionality scores under the initial feature combination weights;

S8: using metric learning to optimize the feature combination weights to update the initial functionality model; and

S9: repeating S2 to S8 to refine the feature combination weights till converge to get the optimal functionality model.

This invention doesn't rely on the interaction between human and the central object and can handle any static interaction between all kinds of objects; without complex operations like labeling all the dataset, users can get the corresponding results directly.

A person skilled in the art shall understand that the embodiments of the present disclosure can be provided as a method, a system or a computer program product. Therefore, the present disclosure can take the form of a full hardware embodiment, a full software embodiment, or an embodiment with combination of software and hardware aspects. Moreover, the present disclosure can take the form of a computer program product implemented on one or more computer usable storage mediums (including, but not limited to, a magnetic disc memory, CD-ROM, optical storage, etc.) containing therein computer usable program codes.

The present disclosure is described with reference to a flow diagram and/or block diagram of the method, device (system) and computer program product according to the embodiments of the present disclosure. It shall be understood that each flow and/or block in the flow diagram and/or block diagram and a combination of the flow and/or block in the flow diagram and/or block diagram can be realized by the computer program instructions. These computer program instructions can be provided to a general computer, a dedicated computer, an embedded processor or a processor of other programmable data processing device to generate a machine, such that the instructions performed by the computer or the processor of other programmable data processing devices generate the device for implementing the function designated in one flow or a plurality of flows in the flow diagram and/or a block or a plurality of blocks in the block diagram.

These computer program instructions can also be stored in a computer readable memory capable of directing the computer or other programmable data processing devices to operate in a specific manner, such that the instructions stored in the computer readable memory generate a manufactured article including an instruction device that implements the function(s) designated in one flow or a plurality of flows in the flow diagram and/or a block or a plurality of blocks in the block diagram.

These computer program instructions can also be loaded onto the computer or other programmable data processing devices, such that a series of operation steps is executed on the computer or other programmable devices to generate the processing realized by the computer, therefore the instructions executed on the computer or other programmable devices provide the steps for implementing the function designated in one flow or a plurality of flows in the flow chart and/or a block or a plurality of blocks in the block diagram.

The above are only the preferable embodiments of the present disclosure, and are not used for limiting the present disclosure. For a person skilled in the art, the embodiments of the present disclosure can be modified and changed variously. Any modification, equivalent substitutions and improvements within the spirit and principle of the present disclosure shall be contained in the protection scope of the present disclosure.

1. The functionality analysis method of given 3D models, comprising:
computing interaction context for the central object given in each scene, where the interaction context is a hierarchical structure which encodes the interaction bisector surface and interaction region between the central object and any interacting object, and the central object needs to be put in a scene to compute the corresponding interaction context;
building the correspondence among those scenes based on the computed interaction context;
extracting the functional patches on each central object in each scene based on the built correspondence, and forming a set of proto-patches which is a key component of the functionality model;
sampling a set of points on each consisting functional patch for each proto-patch and computing a set of geometric features;
learning a regression model from the geometric features on sample points to their weights for each proto-patch;
computing the unary and binary features of each functional patch, where the unary features encode the geometric feature of each single functional patch while the binary feature encode the structural relation between any two functional patches; and
refining the feature combination weights to get the final functionality model, where the feature combination weights are used to combine those unary and binary features.

2. The functionality analysis method of given 3D models according to claim 1, wherein building the correspondence among those scenes based on the computed interaction context, further comprising:
getting the correspondence between each pair of scenes based on the subtree isomorphism between the interaction contexts of those two scenes; and
building a correspondence across the whole set of scenes by selecting the optimal path from those binary correspondences between all pairs of scenes.

3. The functionality analysis method of given 3D models according to claim 2, wherein building a correspondence across the whole set of scenes by selecting the optimal path from those binary correspondences between all pairs of scenes, further comprising:
building a graph for the given scene dataset, where each node corresponds to the central object of one scene and each edge encodes the distance between the interaction contexts of those two central objects corresponding to the two connecting nodes; and
finding the minimal spanning tree of the graph mentioned above, and then expanding the correspondence between each pair of scenes to the whole set based on the spanning tree.

4. The functionality analysis method of given 3D models according to claim 3, wherein expanding the correspondence between each pair of scenes to the whole set based on the spanning tree, further comprising:
randomly picking one node in the scene graph as the root node, and finding the nodes that directly connect to the root to determine the initial set of correspondences; and
using Breadth-First-Search method to recursively propagate the already determined correspondence between the parent node and children nodes to the next level of children nodes.

5. The functionality analysis method of given 3D models according to claim 1, wherein extracting the functional patches on each central object in each scene based on the built correspondence, further comprising:
getting the interacting objects that corresponding to the nodes on the first level of each interaction context in each scene; and
computing the interaction regions between those interacting objects and the central object and then getting the functional patches on each central object.

6. The functionality analysis method of given 3D models according to claim 5, wherein the interaction region is represented by a weight assignment on all the sampled points, where the weight indicates the importance of the point to the specific interaction region.

7. The functionality analysis method of given 3D models according to claim 5, wherein each functional patch has a corresponding functional space, which is the empty space needed for the interacting object and central object to perform such interaction and bounded by the intersection bisector surface between the central object and interacting objects.

8. The functionality analysis method of given 3D models according to claim 1, wherein each proto-patch consists of a set of corresponding functional patches and functional space and the functional space of the proto-patch is then defined as the intersection of all the corresponding functional spaces after aligned.

9. The functionality analysis method of given 3D models according to claim 1, wherein the geometric features computed for each sample point include how linear-, planar- and spherical-shaped the neighborhood of the point is, the angle between the normal of the point and the upright direction of the shape, angles between the covariance axes and the upright vector, height feature, the relation between the point and the shape's convex hull, and ambient occlusion.

10. The functionality analysis method of given 3D models according to claim 9, wherein computing how linear-, planar- and spherical-shaped the neighborhood of the point is, further comprising:
taking a small geodesic neighborhood of each sampled point on the given object;
computing the eigenvalues λ₁, λ₂, λ₃ and corresponding eigenvectors μ₁, μ₂, μ₃ of the neighborhood's covariance matrix, where λ₁≧λ₂≧λ₃≧0; and
defining the features which indicate how linear (L)-, planar (P)- and spherical (S)-shaped the neighborhood of the point is respectively as:
$$L = \frac{{λ}_{1} - {λ}_{2}}{{λ}_{1} + {λ}_{2} + {λ}_{3}} ; P = \frac{2 ( {λ}_{2} - {λ}_{3} )}{{λ}_{1} + {λ}_{2} + {λ}_{3}} ; S = \frac{3 {λ}_{3}}{{λ}_{1} + {λ}_{2} + {λ}_{3}} .$$

11. The functionality analysis method of given 3D models according to claim 9, wherein computing the relation between the point and the shape's convex hull further comprising:
connecting a line segment from the point to the center of the shape's convex hull and recording the length of this segment and the angle of the segment with the upright vector.

12. The functionality analysis method of given 3D models according to claim 1, wherein computing the unary features of each functional patch based on the geometric features further comprising: computing the point-level geometric feature first and then building a histogram capturing the distribution of the point-level features in such patch.

13. The functionality analysis method of given 3D models according to claim 9, wherein computing the binary features of each pair of functional patches, further comprising:
for each pair of functional patches of any central object in a scene, connecting a line segment from a sampled point on one patch to any sampled point on the other patch, and computing the length of this segment and the angle of the segment with the upright vector; and
building a histogram capturing the distribution of the segment lengths and angles computed from all the pairs of sampled points.

14. The functionality analysis method of given 3D models according to claim 1, wherein refining the feature combination weights to get the final functionality model, further comprising:
S1: setting the initial feature combination weights as uniform weights and getting the initial functionality model;
S2: using the learned regression model to predict the functional patches on each central object and getting the initial set of functional patches;
S3: for each initial functional patch, computing the initial unary feature distance between this initial functional patch and the proto-patch of the initial functionality model, which results in a set of minimal unary feature distances;
S4: for each pair of initial functional patches, computing the initial binary feature distance between this initial functional patches and the proto-patches of the initial functionality model, which results in a set of minimal binary feature distances;
S5: combining those initial sets of minimal unary and binary feature distances using the initial set of feature combination weights to get the initial functionality score for each central object;
S6: representing the functionality score can as a function of the weights on the points sampled on the functional patches and refining the points weights and thus functional patches by optimizing the functionality score;
S7: repeating S3 to S6 to refine the functional patches till converge to get the optimal functionality scores under the initial feature combination weights;
S8: using metric learning to optimize the feature combination weights to update the initial functionality model; and
S9: repeating S2 to S8 to refine the feature combination weights till converge to get the optimal functionality model.

15. The functionality analysis apparatus of given 3D models, comprising:
an interaction context computation unit configured to compute interaction context for the central object given in each scene, where the interaction context is a hierarchical structure which encodes the interaction bisector surface and interaction region between the central object and any interacting object and the central object needs to be put in a scene to compute the corresponding interaction context;
a correspondence establish unit configured to build the correspondence among those scenes based on the computed interaction context;
a proto-patch extraction unit configured to extract the functional patches on each central object in each scene based on the built correspondence, and forming a set of proto-patches which is a key component of the functionality model;
a geometric feature computation unit configured to sample a set of points on each consisting functional patch for each proto-patch and compute a set of geometric features;
a regression model learning unit configured to learn a regression model from the geometric features on sample points to their weights for each proto-patch;
a patch feature computation unit configured to compute the unary and binary features of each functional patch, where the unary features encode the geometric feature of each single functional patch while the binary feature encode the structural relation between any two functional patches; and
a functionality model establish unit configured to refine the feature combination weights to get the final functionality mode, where the feature combination weights are used to combine those unary and binary features.

16. The functionality analysis apparatus of given 3D models according to claim 15, wherein the correspondence establish unit further comprising:
a first correspondence establish module configured to get the correspondence between each pair of scenes based on the subtree isomorphism between the interaction contexts of those two scenes;
a second correspondence establish module configured to build a correspondence across the whole set of scenes by selecting the optimal path from those binary correspondences between all pairs of scenes.

17. The functionality analysis apparatus of given 3D models according to claim 16, wherein that the second correspondence establish module further comprising:
a graph construction module configured to build a graph for the given scene dataset, where each node corresponds to the central object of one scene and each edge encodes the distance between the interaction contexts of those two central objects corresponding to the two connecting nodes; and
a correspondence propagation module configured to find the minimal spanning tree of the graph mentioned above, and then propagate the correspondence between each pair of scenes to the whole set based on the spanning tree.

18. The functionality analysis apparatus of given 3D models according to claim 17, wherein the correspondence propagation module further comprising:
a children node determination module configured to randomly pick one node in the scene graph as the root node, and find the nodes that directly connect to the root to determine the initial set of correspondences; and
a correspondence propagation module configured to recursively propagate the already determined correspondence between the parent node and children nodes to the next level of children nodes using Breadth-First-Search method.

19. The functionality analysis apparatus of given 3D models according to claim 15, wherein the proto-patch extraction unit further comprising:
an interacting object determination module configured to get the interacting objects that corresponding to the nodes on the first level of each interaction context in each scene; and
a functional patch localization module configured to compute the interaction regions between those interacting objects and the central object and then get the functional patches on each central object.

20. The functionality analysis apparatus of given 3D models according to claim 19, wherein the interaction region is represented by a weight assignment on all the sampled points, where the weight indicates the importance of the point to the specific interaction region.

21. The functionality analysis apparatus of given 3D models according to claim 20, wherein each functional patch has a corresponding functional space, which is the empty space needed for the interacting object and central object to perform such interaction and bounded by the intersection bisector surface between the central object and interacting objects.

22. The functionality analysis apparatus of given 3D models according to claim 15, wherein each proto-patch consists of a set of corresponding functional patches and functional space and the functional space of the proto-patch is then defined as the intersection of all the corresponding functional spaces after aligned.

23. The functionality analysis apparatus of given 3D models according to claim 15, wherein the geometric features computed for each sample point include how linear-, planar- and spherical-shaped the neighborhood of the point is, the angle between the normal of the point and the upright direction of the shape, angles between the covariance axes and the upright vector, height feature, the relation between the point and the shape's convex hull, and ambient occlusion.

24. The functionality analysis apparatus of given 3D models according to claim 15, wherein the geometric feature computation unit further comprising:
a neighborhood determination module configured to take a small geodesic neighborhood for each sampled point;
the first computation module configured to compute the eigenvalues λ₁, λ₂, λ₃ and corresponding eigenvectors μ₁, μ₂, μ₃ of the neighborhood's covariance matrix, where λ₁≧λ₂≧λ₃≧0; and
the second computation module configured to define the features which indicate how linear (L)-, planar (P)- and spherical (S)-shaped the neighborhood of the point is respectively as:
$$L = \frac{{λ}_{1} - {λ}_{2}}{{λ}_{1} + {λ}_{2} + {λ}_{3}} ; P = \frac{2 ( {λ}_{2} - {λ}_{3} )}{{λ}_{1} + {λ}_{2} + {λ}_{3}} ; S = \frac{3 {λ}_{3}}{{λ}_{1} + {λ}_{2} + {λ}_{3}} .$$

25. The functionality analysis apparatus of given 3D models according to claim 23, wherein computing the relation between the point and the shape's convex hull further comprising: connecting a line segment from the point to the center of the shape's convex hull and recording the length of this segment and the angle of the segment with the upright vector.

26. The functionality analysis apparatus of given 3D models according to claim 15, wherein the patch feature computation module is used to compute the unary features of each functional patch based on the geometric features, which means to compute the point-level geometric feature first and then build a histogram capturing the distribution of the point-level features in such patch.

27. The functionality analysis apparatus of given 3D models according to claim 15, wherein the patch feature computation module for binary feature further comprising:
a point-level feature computation module configured to connect a line segment from a sampled point on one patch to any sampled point on the other patch for each pair of functional patches of any central object in a scene, and compute the length of this segment and the angle of the segment with the upright vector; and
a histogram construction module configured to build a histogram capturing the distribution of the segment lengths and angles computed from all the pairs of sampled points and get the final binary feature.

28. The functionality analysis apparatus of given 3D models according to claim 15, wherein the functionality model establish unit further comprising:
an initial functionality model generation module configured to set the initial feature combination weights as uniform weights and get the initial functionality model;
an initial functional patch localization module which uses the learned regression model to predict the functional patches on each central object and gets the initial set of functional patches;
a unary feature computation module configured to compute the initial unary feature distance between each initial functional patch and the proto-patch of the initial functionality model, resulting in a set of minimal unary feature distances;
a binary feature computation module configured to compute the initial binary feature distance between each pair of initial functional patches and the proto-patches of the initial functionality model, which results in a set of minimal binary feature distances;
a functionality score computation module configured to combine those initial sets of minimal unary and binary feature distances using the initial set of feature combination weights to get the initial functionality score for each central object;
a functional patch optimization module configured to represent the functionality score as a function of the weights on the points sampled on the functional patches and refine points weights and thus functional patches by optimizing the functionality score;
a functionality score optimization module configured to repeat S3 to S6 to refine the functional patches till converge to get the optimal functionality scores under the initial feature combination weights;
a functionality model optimization module, which uses metric learning to optimize the feature combination weights, to update the initial functionality model; and
a functionality model finalization module configured to repeat S2 to S8 to refine the feature combination weights till converge to get the optimal functionality model.

29. A device, comprising:
a processor; and
a memory for computer readable instructions, which when being executed, enable the processor to perform the operations of:
computing interaction context for the central object given in each scene, where the interaction context is a hierarchical structure which encodes the interaction bisector surface and interaction region between the central object and any interacting object, and the central object needs to be put in a scene to compute the corresponding interaction context;
building the correspondence among those scenes based on the computed interaction context;
extracting the functional patches on each central object in each scene based on the built correspondence, and forming a set of proto-patches which is a key component of the functionality model;
sampling a set of points on each consisting functional patch for each proto-patch and computing a set of geometric features;
learning a regression model from the geometric features on sample points to their weights for each proto-patch;
computing the unary and binary features of each functional patch, where the unary features encode the geometric feature of each single functional patch while the binary feature encode the structural relation between any two functional patches; and
refining the feature combination weights to get the final functionality model, where the feature combination weights are used to combine those unary and binary features.
